(19) United States
(12) Patent Application Publication
(10) Pub. No.: US 2026/0222240 A1
(43) Pub. Date: Jul. 30, 2026

(54) Multicast Flow-Zone Switching

(71) Applicant: Roger B. Marks, Denver, CO (US)

(72) Inventor: Roger B. Marks, Denver, CO (US)

(73) Assignee: Consensii LLC, Denver, CO (US)

(21) Appl. No.: 19/146,004

(22) PCT Filed: Jan. 8, 2024
(86) PCT No.: PCT/US2024/010765

§ 371 Date: Jul. 7, 2025

Related U.S. Application Data
(60) Provisional application No. 63/478,927, filed on Jan. 7, 2023.
(60) Provisional application No. 63/479,169, filed on Jan. 9, 2023.

(51) Int. Cl. H04L 12/18; H04L 12/12; H04L 45/16; H04L 45/48; H04L 45/74

(52) U.S. Cl. CPC H04L 12/1886; H04L 12/12; H04L 45/16; H04L 45/48; H04L 45/74

(57) ABSTRACT

A multicast flow-zone switching method and system are disclosed. Stations use allocated address blocks to label multicast egress frames with identifying information, which may include a destination zone map and a source zone identifier. Frames may be marked with an arborescence set identifier during transit through a core network. Core zones may use a source branch identifier and arborescence set identifier in the frame to restrict transmission to paths following one or more specified arborescences. Frames are delivered only along paths necessary to deliver frames to multicast destinations.

### CROSS REFERENCE TO RELATED APPLICATIONS

The present application is related to, and claims the priority benefit of, commonly-assigned and co-pending provisional U.S. Application Ser. No. 63/478,927, entitled Multicast Flow-Zone Switching, filed on 7 Jan. 2023, and 63/479,169, entitled Multicast Flow-Zone Switching, filed on 9 Jan. 2023, which applications are incorporated herein by reference in their entireties. The present application makes of Flow-Zone Switching as disclosed in my U.S. Pat. No. 11,418,460 B2 (“Flow-Zone Switching”), filed on 14 May 2018, granted on 16 Aug. 2022 and U.S. Pat. No. 11,811,684 B2 (“Flow-Zone Switching”), filed on 7 Jul. 2022, granted on 7 Nov. 2023, which patents are incorporated herein by reference in their entireties. The present application makes use of Block Address Registration and Claiming as disclosed in my international patent application PCT/US2021/054450 (“Network Block Address Registration and Claiming”), filed on 11 Oct. 2021 and incorporated by reference in its entirety.

### TECHNICAL FIELD

The present disclosure relates to data switching and addressing, particularly to multicast switching with zonal and flow-based addressing.

### BRIEF DESCRIPTION OF THE DRAWINGS

For a more complete understanding of the invention, reference is made to the following description and accompanying drawings, in which:

FIG. 1 illustrates an MFZS zone;

FIG. 2 illustrates an MFZS network;

FIG. 3 illustrates core link sets;

FIG. 4 illustrates arborescences;

FIG. 5 illustrates arborescence examples;

FIG. 6 illustrates additional arborescence examples;

FIG. 7 illustrates a branched network example;

FIG. 8 illustrates an MFZS frame;

FIG. 9 illustrates a first address;

FIG. 10 illustrates a second address;

FIG. 11 illustrates a DZM and PZM;

FIG. 12 illustrates a PZM in a branch vertex;

FIG. 13 illustrates a DBM;

FIG. 14 illustrates PBM examples;

FIG. 15 illustrates a PBM lookup;

FIG. 16 illustrates a arborescence port table (APT);

FIG. 17 illustrates a destination station list (DSL); and

FIG. 18 illustrates an MFZS forwarding procedure.

### BACKGROUND ART

In computer data networks, addresses with unique meaning are assigned. Some such addresses (namely, unicast addresses) uniquely identify entities that serve as sources and destinations. Other such addresses (namely, multicast addresses) identify groups of destinations. In some cases, multicast addresses are assigned to specific devices for their use in transmitting information, such as data streams, intended to be received by a set of receiving devices.

Layer 2 networks, such as those based on Ethernet, support data switching (versions of which are often known in Layer 2 networks as “bridging”) and are prominent in many networking applications. Layer 2 switching is known to have benefits. To the extent that data may be successfully forwarded through a network without the need for Layer 3 routing, it may be possible to bypass Layer 3 and the extra overhead it entails in data delivery. In some cases, Layer 2 networking is used to transport Layer 3 packets. While this disclosure is described primarily in terms of Ethernet and similar Layer 2 networks, the principles are applicable to a wide variety of networks, including those operating at Layer 3.

In Layer 2 data networks, frames are typically switched based on the content of the Destination Address (DA) field embedded in the frame. A data switch typically reads the DA field and looks up the resulting address in a forwarding database that provides a forwarding port or ports for the frame based on that lookup. This presumes that the forwarding database includes a record indicating the correct port toward a device matching the DA (possibly subject to VLAN limitations). In the unicast case, that information, if stored in the forwarding database, has typically been determined following receipt, by the switch, of an earlier frame bearing the same address in the Source Address (SA) field. Upon such receipt, the switch learns the association of the port with the address in the SA field and, inferring that the same port is the correct one to which to forward frames with the same address in the DA field, populates the forwarding database accordingly.

If the address identified in the DA is not found in the forwarding database, the switch typically “floods” the frame by forwarding it to all ports, with the expectation that this will lead to its successful delivery regardless of which port leads to the destination. Flooding can consume a large amount of resource in the network, particularly when many unknown devices access it.

In some cases, loops in a network can lead to difficulties in Layer 2 networks, particularly when frame forwarding leads to circulation around the loop.

The problems of loops, learning, and flooding can be partially overcome when the network elements are stable over a long interval. However, another significant problem is related to scale and may be more challenging. The forwarding database of the typical Layer 2 switch needs to contain an entry for the destination address of any frame it receives. This could require some switches to store and recall many addresses, a capability that can add significant expense, especially considering that the addresses are large, typically 48 or more bits. Searching of large databases can also also impose significant delays and significant energy consumption.

In conventional Layer 2 data networks, such as IEEE 802 networks, one particular bit in the address identifies that address as either a global address or a local address. Global addresses are expected to be universal and are therefore generally assigned to the hardware in the manufacturing phase (“burned in”). It is impossible to change or assign such an address within the scope of the standards (other than to toggle a single bit to indicate unicast or multicast). It is therefore difficult to, while maintaining conformance with addressing standards, organize global addresses into a structure that could be interpreted during network switching and frame delivery. The global address structure is non-hierarchical and “flat.”

Global addresses, because of the requirement to be unique throughout all space and time (over many decades), are large. Layer 2 networks, because of their need to be compatible with global addresses, are constructed on the basis of large addresses, even though the span of the local network is typically relatively small.

The local address space, which is the space of addresses in which the “local” bit is set on, is not subject to universal uniqueness, and addresses are not permanently assigned to devices. Therefore, opportunities exist to exploit the large address space, creating structure to aid in switching mechanisms and frame delivery.

U.S. Pat. No. 11,418,460 discloses the use of Flow-Zone Switching, based on local addresses, to solve problems associated with flat Layer 2 networks, particularly when the destination address identifies the zone of the destination. Aspects of that disclosure illustrate the use of structured addressing to aid in frame delivery.

When the destination address is a multicast address, it may identify not one destination but a plurality of them. If those destinations lie in different zones, then some methods of U.S. Pat. No. 11,418,460 may be insufficient.

The current disclosure identifies extensions of Flow-Zone Switching to Multicast Flow-Zone Switching (MFZS), providing efficient switching of multicast frames to a plurality of destination zones.

International patent application PCT/US2021/054450 describes Network Block Address Registration and Claiming, including the disclosure of Address Blocks. An Address Block, as detailed therein, is a contiguous range of unicast addresses and a matching contiguous range of multicast addresses, within the local address space, with properties that make it favorable to address assignment.

The current disclosure describes how, with the addresses drawn from such Address Blocks, additional advantages in Multicast Flow-Zone Switching are attained. The method is particularly applicable to scenarios in which the destination address of the multicast frame is assigned by the transmitter of that frame from among a set of addresses that has been assigned to the transmitter as a Address Block.

### OBJECTS OF THE INVENTION

It is an object of this invention to provide for transmission of multicast frames through a network, limiting transmission to links necessary to deliver the frame to destinations identified in the frame, without requiring switches to be configured for each flow.

Still other objects and advantages of the disclosure will in part be obvious and will in part be apparent from the specification and drawings.

### SUMMARY OF THE INVENTION

In order to overcome the identified problems, this disclosure reveals various methods to ensure that multicast frames are delivered as intended. Information relevant to the delivery may be encoded in frame addresses drawn from an address block assigned to the source.

The invention accordingly comprises the several steps and the relation of one or more of such steps with respect to each of the others, and the apparatus embodying features of construction, combinations of elements and arrangement of parts that are adapted to affect such steps, all is exemplified in the following detailed disclosure, and the scope of the invention will be indicated in the claims.

### DETAILED DESCRIPTION

### MFZS Zones

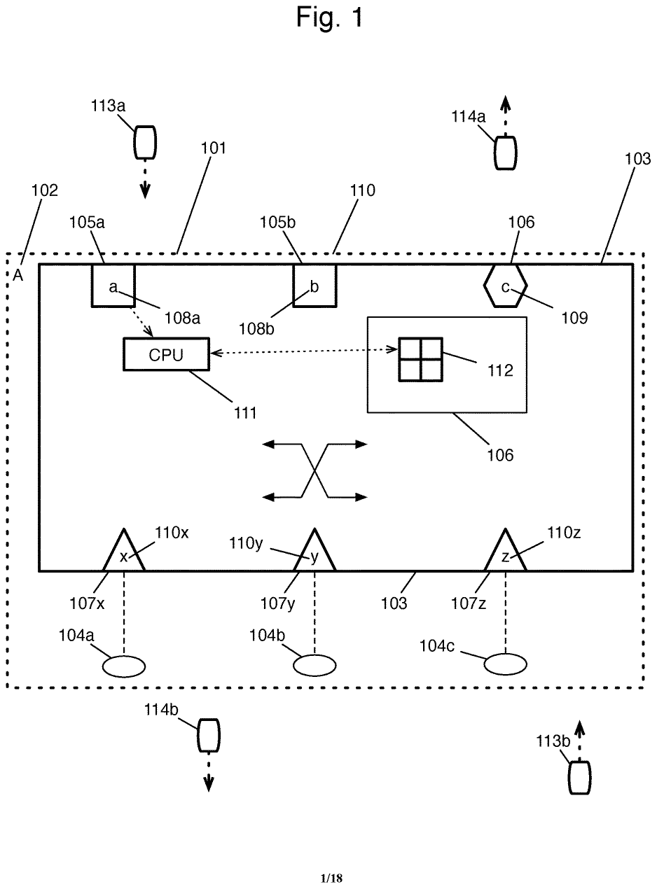

Embodiments of the disclosure include MFZS networks interconnecting MFZS zones, one of which is illustrated in FIG. 1. An MFZS zone [101] is indicated within the domain delimited by the box shown with a dotted boundary. The MFZS zone [101] may be identified by a zone ID [102]; if so, the zone ID [102] is unique within the network, so it identifies one and only one MFZS zone [101]. In some cases, as described below, no zone ID [102] is required or used. In the figure, the zone ID [102] takes the exemplary value “A”. MFZS zone [101] comprises a zone switch [103] and its associated elements, including its ports and stations.

The zone switch [103] includes one or more ports. Each port is characterized as either a core port [105](indicated with a square symbol), branch port [106](indicated with a hexagonal symbol), or a station port [107](indicated with a triangular symbol). Each branch port [106] is enabled to exchange frames with a branch port [106] of another zone switch [103](within a different MFZS zone [101]). Each core port [105] is enabled to exchange frames with a core port [105] of another zone switch [103](within a different MFZS zone [101]), as intermediated by core link set [202]. The quantities of core and branch ports per zone are arbitrary, although an MFZS zone [101] with none of either is of limited interest herein.

Each station port [107] is enabled to exchange frame data with a zone station [104]. The quantity of station ports per zone is arbitrary. An MFZS zone [101] with no station port [107] does not generate frames internally or consume frames but may nevertheless usefully serve to forward frames among other zones, particularly if it has multiple other ports. However, such an MFZS zone [101] may have no need for a zone ID [102] and the zone ID [102] assignment to such an MFZS zone [101] may be null.

Each port is identified uniquely, within the MFZS zone [101], by a port identifier. In particular, each station port [107] is identified by a station port ID [110]; in FIG. 1, station ports 107x, 107y, and 107z are identified by station port ID [110]110x, 110y, and 110z, respectively, taking the value “x”, “y”, and “z” respectively. Likewise, each core port [105] is identified by a core port ID [108]; in FIG. 1, core ports 105a and 105b are identified by core port ID [108]108a and 108b, respectively, taking the value “a” and “b” respectively. Likewise, each branch port [106] is identified by a branch port ID [109]; in FIG. 1, branch port [106] is identified by branch port ID [109] taking the value “c”. Quantities illustrated in this and other figures are exemplary and do not limit the disclosure.

A frame arriving at MFZS zone [101] is known as an ingress frame [113]. A frame departing MFZS zone [101] is known as an egress frame [114]. FIG. 1 includes two examples ([113a] and [113b]) of ingress frame [113] and two examples ([114a] and [114b]) of egress frame [114]. The port identifier of a port at which the ingress frame [113] arrives is its ingress port ID [115]; this is the port ID (core port ID [108], branch port ID [109], or station port ID [110]) of the port (core port [105], branch port [106], or station port [107], respectively) at which the ingress frame was received. The port identifier of a port at which the egress frame [114] departs is its egress port ID [116]; this is the port ID (core port ID [108], branch port ID [109], or station port ID [110]) of the port (core port [105], branch port [106], or station port [107], respectively) at which the egress frame is transmitted. Neither ingress port ID [115] nor egress port ID [116] is explicitly identified in FIG. 1, though the port IDs therein all serve as examples.

A station port [107] may be a virtual port, without a physical manifestation as an interface to the outside of a zone switch [103]. For example, the interface may be an internal interface to a process executing in a processor (such as processor [111]) within zone switch [103]. In the disclosure, such an internal virtual port is represented as a station port [107] with which frame data can be exchanged by the zone switch [103], and the local process serves as a zone station [104] in that case. The format in which frame data is exchanged with a virtual port may vary from the format in which it is exchanged with a physical port.

The zone switch [103] is equipped with a processor [111], which is enabled to read the zone ID [102]. The processor [111] is enabled to read frame content, configuration data, and instructions from memory [112] and write frame content, configuration data, and instructions to memory [112]. An ingress frame received at a port (its ingress port) is copied to the processor [111] for processing, along with its ingress port ID [115]. The processor [111] is enabled to distinguish, based on its port ID, the type of each port; that is, whether is is a station port [107], a core port [105], or a branch port [106].

The processor [111] is enabled to prepare an egress frame and direct it to one or more specific ports (its egress ports) by designating one more values of egress port ID [116]. The zone switch [103] is enabled to transmit an egress frame via an egress port, as directed by the processor [111].

In embodiments, processor [111] is prepares an itemization of egress port ID [116] values for an egress frame before forwarding it to the associated egress ports. This itemization takes various forms in various embodiments. One form is a list of each indicated egress port ID [116]. Without loss of generalization, this description presumes that the itemization is carried as the contents of the frame's binary-valued Egress vector, designating the frame to be forwarded to port i if and only if the value Egress[i] is set to 1. In embodiments, processor [111] is enabled to prepare the frame's Egress vector by determining, for any port i, that port i will be a forwarding port for the frame, accordingly setting Egress[i] to 1 in memory [112], and setting Egress[i] to 0 for a port i not determined to be a forwarding port.

### MFZS Network and Branches

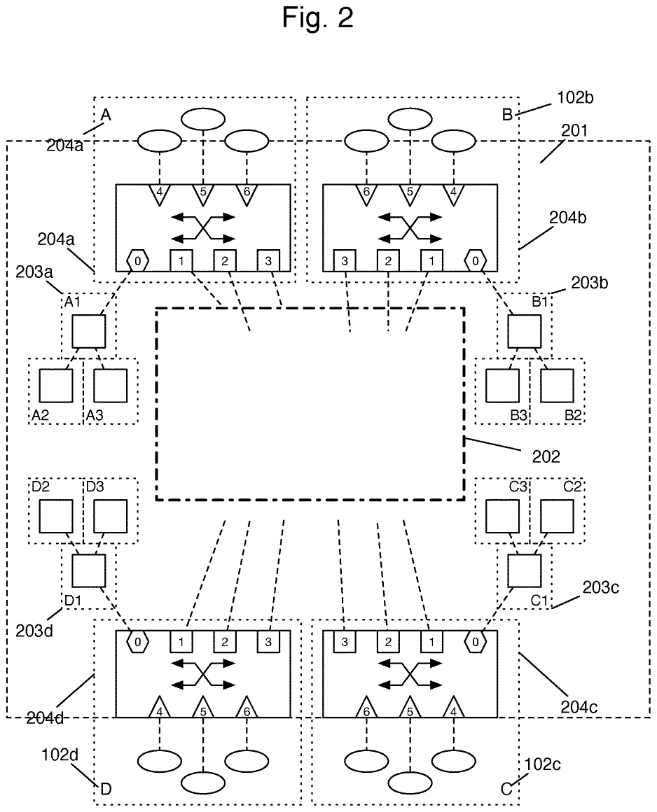

Embodiments of the disclosure include MFZS networks, such as MFZS network [201] illustrated in FIG. 2, with interconnected MFZS zones. The figure indicates a MFZS network [201] of several MFZS zones, but the number of zones is arbitrary, and quantities illustrated in the figure are not limiting. In MFZS network [201], an MFZS zone [101] is either an MFZS core zone [204] or an MFZS branch zone [203]. Any MFZS zone [101] in the network may identified within the network by zone ID [102], with each such zone ID [102] assigned uniquely within MFZS network [201]. In the example illustrated, each of MFZS core zone [204]204a, 204b, 204c, and 204d is uniquely identified within the network, by zone ID [102] values “A”, “B”, “C”, and “D”, respectively.

An MFZS core zone [204] of MFZS network [201] is interconnected with a core link set [202], which is enabled to forward a frame among MFZS core zones, in accordance with limitations based on connectivity provided. The core link set [202] comprises a set of links, each linking a single core port [105] in a zone switch [103] of an MFZS core zone [204] to a single core port [105] in a zone switch [103] of a different MFZS core zone [204].

As illustrated in FIG. 2, zones may also be connected by branch port [106]. An MFZS zone [101] connected only by branch ports is called a MFZS branch zone [203]. For example, FIG. 2 illustrates an MFZS branch zone [203](with zone ID [102] value “A1”) connected to zone A. This connection is made by interconnecting a branch port [106] in zone A to a branch port [106] in zone A1. As illustrated, additional zones may be connected to zone A1, by additional branch port [106] connections. Although not illustrated, this process may be repeated, with additional zones connected to zone A1, A2, A3, etc. Each such zone is a MFZS branch zone [203]. A zone switch [103] at an MFZS branch zone [203] may be equipped with station port, to which stations are attached. A zone switch [103] at an MFZS branch zone [203] is not equipped with a core port [105], and zone switch [103] may be configured to determine, by the presence or absence of a core port [105], whether it is in an MFZS core zone [204] or in an MFZS branch zone [203].

A set of co-connected branch zones, along with the MFZS core zone [204] to which they are connected, is known a a branch. The MFZS core zone [204] of the branch is also known as the branch vertex of that branch. A branch may include sub-branches from multiple branch ports of a common MFZS core zone [204]; those branches share a common branch vertex.

In the disclosure herein, the connectivity among the branch zones of a branch is presumed to be loop-free.

### MFZS Core

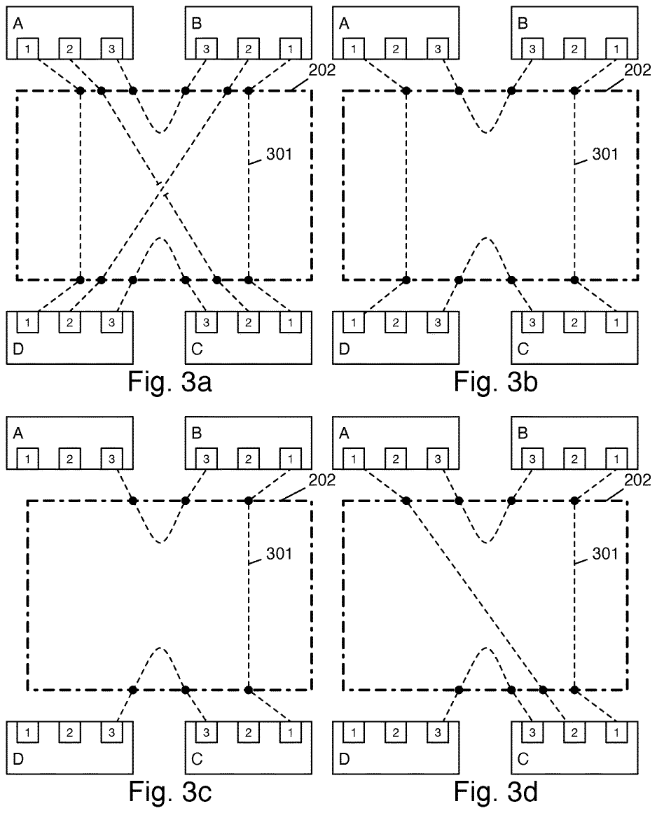

FIGS. 3a through 3d provide examples of a core link set [202] suitable for the MFZS network [201] of FIG. 2. In each of these figures, the core ports of each MFZS core zone [204] of FIG. 2 are shown for reference. Each of these figures shows an example set of zone links comprising the illustrated core link set [202].

For example, FIG. 3a illustrates a fully connected mesh, linking each MFZS core zone [204] to each other MFZS core zone [204] in the MFZS network [201]. This full connectivity is provided by means of a core link set [202] joining a core port [105] of each MFZS core zone [204] to a core port [105] of each other MFZS core zone [204].

For example, FIG. 3b illustrates a ring configuration, linking each MFZS core zone [204] to two adjacent core zones in the MFZS network [201]. This reduced connectivity requires fewer resources (ports and links). It provides less flexibility than the fully connected mesh and may provide poorer performance since some routes may need to traverse more links.

The example of FIG. 3c illustrates a line configuration, removing one MFZS core zone [204] with respect to the ring connection. This provides less flexibility than the ring configuration, but it may be practical in some circumstances; for example, when two core zones are physically distant.

The example of FIG. 3d provides a further illustration of the flexibility of the model. Here, three of the core zones are connected in a ring configuration and a fourth is connected in point-to-point fashion to one of the core zones in the ring.

As a point of clarification, in the configuration example of FIG. 3d, zone switch D is connected only by a link to zone switch C. In this case, zone switch D could alternatively be represented as a zone station [104] of zone C rather than as a separate zone; in this case, port 3 of zone switch C would be a station port [107] rather than a core port [105]. The disclosure provides for either alternative. One difference is that delivery of a frame to an MFZS zone [101] is arranged according to the assigned a zone ID [102], whereas the zone station [104] shares its zone ID [102] with the receiving zone switch [103] requires extra steps to select the destination zone station [104]. In general, this might suggest that the independent MFZS zone [101] description is preferable. However, the number of zone IDs in the MFZS network [201] may be limited, and the zone station [104] concept provides an opportunity to expand the number of stations beyond the number of available zone IDs.

The examples of FIG. 3a through 3d all provide connectivity among all core zones, so that any station port [107] of a core zone has a potential connection to each other station port [107] of a core zone. The disclosure of MFZS switching is applicable to each of these examples, and to others (regardless of the number of entities involved) that interconnect the MFZS zones. In FIG. 3a through 3d, connections from the core port [105] to the core link set [202] are, for clarity, included in the figure only where relevant to the exemplified connectivity.

### Arborescences

The examples of FIG. 3a through 3d all illustrate connectivity provided among the core zones by the core link set [202]. In general, many routes may exist between two core zones. Many network methods exist to select from among such routes. In the case of Layer 2 networks, loops in the network may lead to routing difficulties, so Layer 2 networks are often operated in a tree configuration, which is loop-free. Among the examples of FIG. 3a through 3d, only FIG. 3c illustrates a tree structure, in which only a single route exists among a pair of station ports. Layer 2 networks conventionally compute a spanning tree that blocks the usage of some links in order to arrive at a connectivity configuration that spans all nodes in the network but blocks all loops. As an example, if the FIG. 3a blocked transmission on all links except those illustrated in FIG. 3c, the result would be a spanning tree that connected all each MFZS zone [101] without loops. One drawback of such a limitation is that efficiency is reduced, since data is confined to fewer links (leading to possible congestion) and some routes become less direct (leading to longer latency, also expressed as transit time). Methods to make spanning trees more flexible have been introduced in the prior art.

In graph theory, the tree is an example of a directionless graph, with nodes connected by directionless edges. The examples of FIG. 3a through 3d are also directionless, reflecting the understanding that the link is bidirectional and carries frames in both directions. The explanation herein is aided by introducing the concept of a directed graph, in which the edges are directional.

The explanation herein is further aided by the introduction of the graph theory concept of an “arborescence.” A convenient definition available in the literature (Weisstein, Eric W. “Arborescence.” From MathWorld—A Wolfram Web Resource. https://mathworld.wolfram.coi says that “A directed graph is called an arborescence if, from a given node x known as the root vertex, there is exactly one elementary path from x to every other node v.” This concept will aid the explanation because it reflects the nature of the problem, which involves a multicast transmission beginning at a root vertex that end at multiple nodes (the destination MFZS zone [101] or zones, receiving the multicast frame).

In the MFZS network [201] of FIG. 2, a full spanning arborescence could be studied, specifying the path from a root vertex at the zone station [104] that originates a multicast frame to every other station. However, the problem can be simplified by studying only arborescences with a root vertex at an MFZS core zone [204]. Any data transmitted to from the MFZS core zone [204] via a branch port [106] or station port [107] is inherently loop-free. Therefore, only one route exists from any zone station [104] to its MFZS core zone [204], and only one route exists from any MFZS core zone [204] to its station port [107]. It is only in the transport among core zones that the arborescence affects the routing.

This disclosure limits its arborescence focus to the core link set [202] and the core zones. The root vertex of the arborescences discussed herein is a MFZS core zone [204].

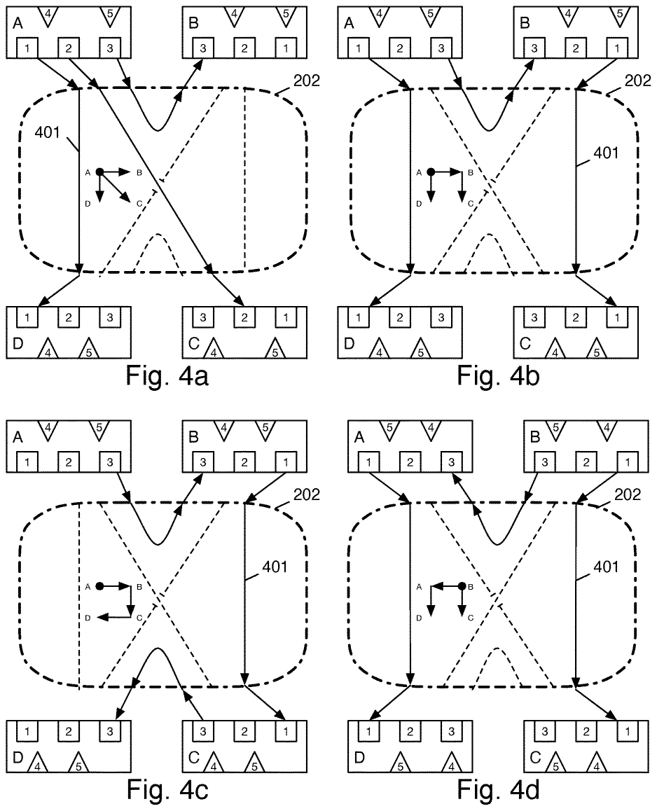

Examples of arborescences are provided in FIG. 4a through 4d. In each of these figures, the core link set [202] of example of FIG. 3a is illustrated. Not every link of that core link set [202] is used in each example; each unused link is shown as a dashed segment. The solid, arrowed segments indicate the directed edges of the arborescence. Inset into each of these figures is a diagram that schematically illustrates the arborescence within the core link set [202], with a solid dot indicating the root vertex and arrowed segments indicating directed edges.

For example, FIG. 4a illustrates an arborescence in which the root vertex is core zone A. The MFZS network [201] may be configured to forwarded a multicast frame from that root vertex in accordance with the arborescence of FIG. 4a. For example, the zone switch [103] of MFZS zone [101] A may forward the frame to station ports or branch ports of MFZS zone [101] A, but this is independent of arborescence. The zone switch [103] of MFZS zone [101] A may also forward the frame directly to other MFZS zones; in the example, it forwards it to MFZS zone [101] B, C, and D via core port [105] 3, 2, and 1, respectively. By this means, the illustrated arborescence is enabled to forward the frame from the root vertex to each MFZS core zone [204]. Each MFZS core zone [204] is enabled to, upon receipt, forward the frame to its station or branch ports.

The example of FIG. 4b illustrates a different arborescence, with the same root vertex as that of FIG. 4a, in which the frame is routed to MFZS zone [101] C via MFZS zone [101] B rather than directly from MFZS zone [101] A. This is consistent with a ring or line configuration of the core link set [202]. Delivery of the frame to MFZS zone [101]C may be slower than in example of FIG. 4a due to the indirect route.

The example of FIG. 4c illustrates an arborescence, with the same root vertex as that of FIG. 4a, in which the frame is routed to MFZS zone [101] C via MFZS zone [101] B and to to MFZS zone [101] D via MFZS zone [101] B and MFZS zone [101] C sequentially. Delivery of the frame to MFZS zone [101] D may be slower than to MFZS zone [101] C of the same example.

The example of FIG. 4d illustrates an arborescence that is similar to that of FIG. 4b but in which the root vertex is station port [107] 4 of MFZS zone [101] B. While the (undirected) tree of indicated within the core link set [202] is identical in FIG. 4b and FIG. 4d, the arborescences differ because the root vertices and directions differ.

This disclosure explains how the MFZS network [201] provides one more more arborescences with a root vertex at an MFZS core zone [204] that transmits MFZS frames, detailing how those arborescences are implemented in the core switches and the core link set [202].

All the examples of FIG. 4a through 4d illustrate spanning arborescences, which are those that reach each MFZS core zone [204]. While the focus of MFZS operation is on multicast frames, it is also applicable to broadcast frames, which are intended for receipt at each station port [107]. Each spanning arborescence provides a route for such distribution.

Some embodiments of the MFZS network [201] support non-spanning arborescences; for example, for carrying multicast frames for which delivery to some MFZS zones is not required. However, limiting the distribution of frames by non-spanning arborescences is, in some cases, a nonideal means of limiting the distribution of multicast frames. Herein, references to arborescences generally refer to spanning arborescences, unless otherwise stated, and other means for limiting the distribution are disclosed.

In the typical case, multicast frames are intended for some stations but not all. A particular arborescence is enabled to reach each MFZS core zone [204] within it, but delivery of the frame to an MFZS core zone [204] with no intended destination at or beyond that zone may be inefficient. In the example of FIG. 4b, a frame may be intended for MFZS zone B only. In such a case, it would be inefficient for MFZS zone A to forward it to MFZS zone D; also, it would be inefficient for MFZS zone B to forward the frame to MFZS zone C. Likewise, a frame intended for MFZS zone [101] C only need not be forwarded to MFZS zone D but could be forwarded to MFZS zone B during transmit to MFZS zone C.

This disclosure explains how the MFZS network [201] is arranged so as forward frames along a branch of the arborescence only if intended destinations lie along that branch. It also discloses how the set of intended destinations of a multicast frame can be assigned by the originating zone station [104].

In general, a frame delivered to a MFZS zone [101] is not necessarily intended for delivery to each zone station [104] within that MFZS zone [101]. Delivery to unintended ports can have negative consequences. For example, filtering of the unintended frames by the recipient adds burden and complexity to the recipient and can cause congestion at an egress station port [107].

This disclosure explains how the MFZS network [201] is arranged so that a MFZS zone [101] refrains from forwarding a frame to an unintended zone station [104].

### Orthogonal Arborescences and Arborescence Sets

For operational efficiency, some embodiments make use of arborescence sets. Herein, an arborescence set comprises a set of distinct spanning arborescences, sharing the same root vertex, each of which is orthogonal to the others. Herein, two arborescences are orthogonal (i.e., orthogonal to each other) unless they share an edge leading into a node and diverge leaving that node. If two arborescences are orthogonal, then a receiving zone is able to ascertain the forwarding direction based on knowledge of the arborescence set and the ingress port. This is impossible with non-orthogonal arborescences since the zone following the shared edge sees them on the same ingress port.

As a result of this definition of orthogonal sets, an egress port can support no more than one arborescence per arborescence set since, if two arborescences of the same set were sent from the same port, the receiving zone could not distinguish them. So, for example, a three-port MFZS core zone [204] could support an arborescence set with three arborescences, with each of those arborescences leaving the root vertex via a different port. If an arborescence set with two arborescences was specified, then one of those could leave the root vertex at two ports. If an arborescence set with one arborescence was specified, then it could leave the root vertex at one, two, or three ports.

### Arborescence Examples

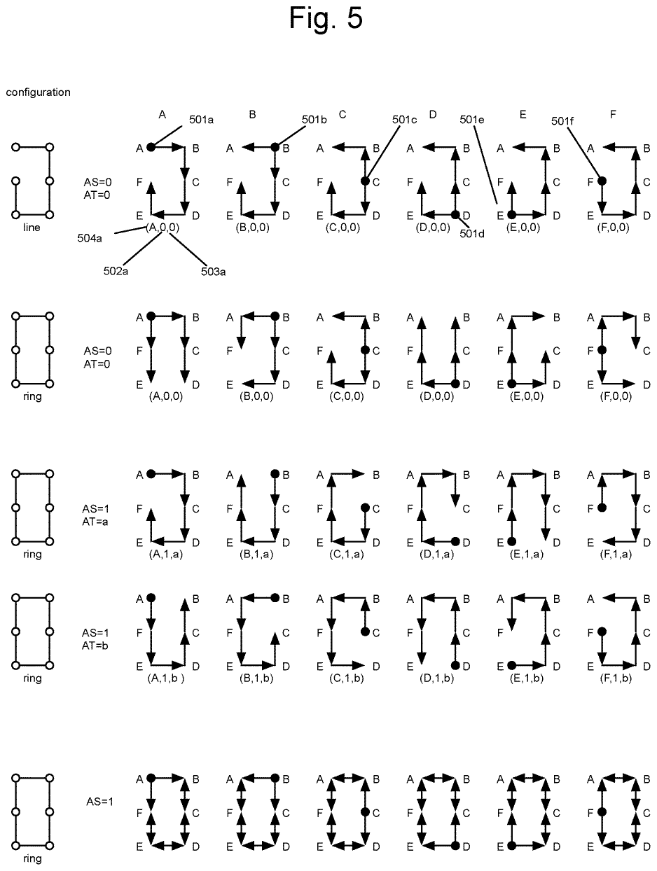

Example arborescences are provided in FIG. 5. Each example includes six instances of MFZS zone [101], identified as A through F.

The top row of FIG. 5 illustrates a core link set [202] configured in a line configuration, as in FIG. 3c, connecting each MFZS core zone [204] to its neighbors, with one exception. Since this network is a tree, only a single arborescence is possible for each root vertex [501]. This single arborescence is, in each case, identifiable by a root vertex; an arborescence set (AS [502]) value is, in this example, set to AS=0. The diagrams in the top row of FIG. 5 illustrate the arborescence for each root vertex, as labeled at the top of the column. The structure of the arborescences differ significantly based on the root vertex; for example, the A arborescence (i.e., the one with root vertex A) is purely clockwise, the F arborescence is purely counterclockwise, and the other arborescences run in two directions from the root vertex. Nevertheless, since each root vertex supports only one arborescence, it may be convenient to number each with the same AS. Each arborescence is identified by an arborescence identifier (AID [504]) indicated as the three-parameter quantity designated as (root vertex,AS,AT) and displayed below each diagram. In general, the arborescence type (AS [502]) distinguishes the arborescences with the AS. However, in this case, there is only one such arborescence and AT is set to 0.

The additional rows of FIG. 5 illustrate various arborescences, for the six root vertices, for a core link set [202] configured in a ring configuration, as in FIG. 3b. Not all possible arborescences are shown. Instead, three example arborescences are illustrated for each root vertex, each in a row represented by the AS and AT shown in that row. In the ring configuration of FIG. 5, the example arborescences are identified with AS values of 0 and 1. The arborescence is identified by AID [504] again indicated as the three-parameter quantity designated as (root vertex,AS,AT) and displayed below each diagram. In this numbering approach, typical of some embodiments, each AT [503] has common properties, independent of the root vertex; this simplifies routing calculations and the specification of arborescences. In this example, for any root vertex I:
arborescence (I,0,0) begins at the root vertex and extends in both directions, covering three zones in the clockwise direction and two zones in the counterclockwise direction, spanning all zones;
arborescence (I,1,a) a begins at the root vertex and extends only clockwise, spanning all zones; and
arborescence (I,1,b) begins at the root vertex and extends only counterclockwise, spanning all zones.

A simple examination reveals that, for any root vertex I, the (I,1,a) and (I,1,a) arborescences are orthogonal. In the ring configuration, any node receiving a frame can distinguish among the clockwise and counterclockwise arborescences by virtue of the fact that frames of the clockwise arborescence are received from the port facing in the counterclockwise direction, and vice versa. This is illustrated in the bottom row of FIG. 5, which superimposes the (I,1,a) and (I,1,a) arborescences diagrams. In the illustrations, segments with solid arrows at each end forward data in both directions and the data is forwarded by the receiving zone as indicated.

To aid in understanding how this example of the ring configuration arborescences can be applied, consider:
arborescence (I,0,0) divides the zones roughly in half, and the most distant zone is three hops from the root vertex;
arborescence (I,1,a) provides that the most distant zone is five hops from the root vertex and, while this could be undesirable in some settings, might be advantageous in others; and
arborescence (I,1,b) is similar to (I,1,a) but in the opposite direction, which might be beneficial depending on, for example, which MFZS core zone [204] or zones had the most demanding latency requirements.

Another option is to use AS=1 but superpose a frame on both AT=a and AT=b; e.g., to transmit from MFZS zone A on both the (A,1,a) and (A,1,b) arborescences. This choice delivers the frame in duplicate to all designated MFZS zones in the network. Some network designs intentionally seek such duplication for improved robustness and/or latency. For example, this design makes a network more robust to link failure; in the case of the superposition, no single link failure would prevent at least one copy of the frame from arriving at each destination zone. Such frame duplication may result in out-of-order frame reception; techniques to address this problem, such as numbering frames with a serial number, are well known and not be presented herein.

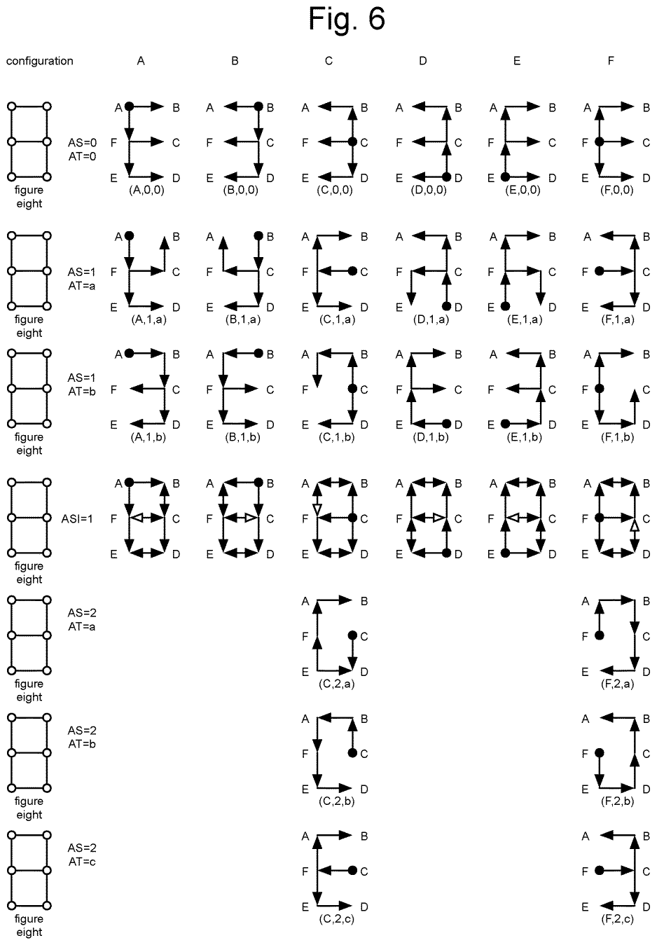

Further example of arborescences are provided in FIG. 6, which considers a core link set [202] configured in a “figure eight” configuration, similar to the ring but with a link between zones C and F. Again, a subset (in this case, three examples) of possible arborescence sets for each root vertex is illustrated and provided with an identifier. The root vertices A, B, D, and E are symmetric in the network, and the example arborescences are similar among that subset. The root vertices C and F differ from the former in structure (for example, with three ports rather than two) but are symmetric relative to each other in the network, and the example C and F arborescences are similar.

The first row indicates arborescences with AS=0 and AT=0, with arborescence names shown below the diagrams, in each case based on the root vertex and the AS and AT identifiers. Since each of these arborescences occupies all egress ports of the root vertex, the AS includes only a single AT.

The second and third rows show arborescences with AS=1 and the property that, for each root vertex, the two identified arborescence types (AT=a and AT=b) are orthogonal. For clarity, the fourth row of the figure illustrates the superposition of those two. In the diagrams, segments with a hollow arrow indicate that that data is forwarded along that segment, in the direction of the hollow arrow, to the recipient zone but not forwarded beyond that recipient zone. Such superposition can make a network more robust to link failure. In these examples, no single link failure would prevent at least one copy of the frame from arriving at each destination zone.

In the “figure eight” configurations, some embodiments might preferentially assign the AT=1 arborescence for latency advantage since, for example, only one path is more than two links from the source. However, some embodiments might assign the orthogonal pair for frames in which redundancy for reliability was to be emphasized.

FIG. 6 also illustrates a third AS, labeled AS=2, with three orthogonal arborescences, in the last three rows of the figure. Such a threesome is impossible for core zones A, B, D, and E, since they have only two core ports each. However, diagrams illustrate three orthogonal C arborescences and three orthogonal F arborescences.

### Branched Network Example

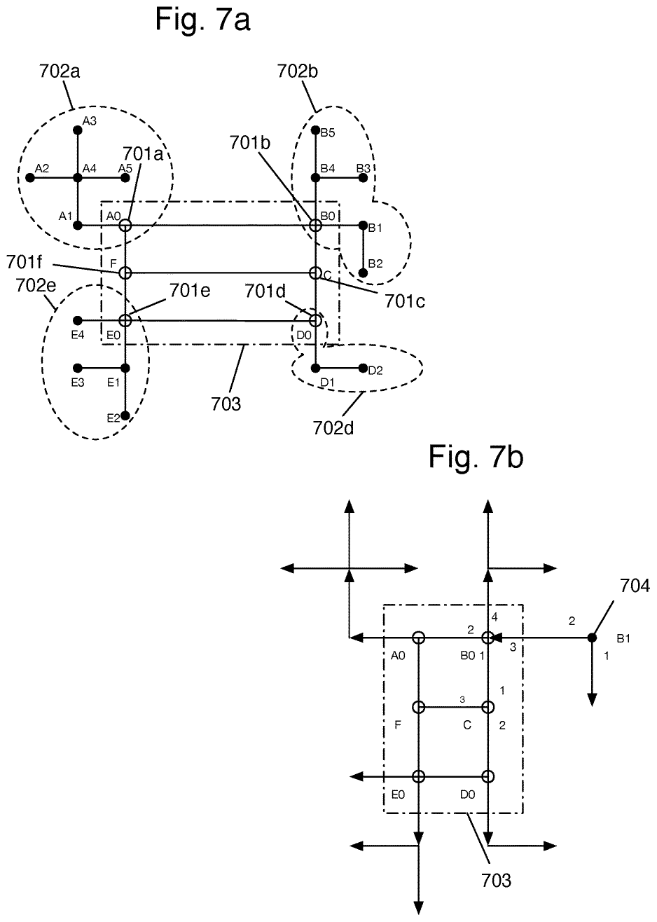

FIG. 7a illustrates an example of an MFZS network [201] including core subnetwork [703] comprising six instances of MFZS core zone [204](701a, 701b, 701c, 701d, 701e, and 701f, labeled A, B, C, D, E, and F, respectively), connected in a figure-eight configuration. Connected to the core zones are various branches, each such branch [702] taking the form of a tree. FIG. 7a illustrates four such branches: 702a, 702b, 702d, and 702e, each attached at a respective MFZS core zone [204] known as the branch vertex [701] of its branch [702]. As illustrated, each such branch [702] includes its branch vertex [701]. As a consequence, multiple sub-branches attached to a branch vertex via different ports are treated as a single branch. For example, branch 702b includes two sub-branches attached to branch vertex 701b by different ports, but both are part of the same branch 702b with branch vertex 701b. Each branch vertex [701] also belongs to core subnetwork [703]. An MFZS zone [101] of core subnetwork [703] with no attached branch zones, such as MFZS zones 701c and 701f of FIG. 7a, is also a branch, though containing only a single MFZS zone, which is the branch vertex [701].

FIG. 7b provides an example, based on the example of FIG. 7a, of a multicast frame routing. In this example, a frame originates within exemplary source zone [704], labeled as MFZS zone B1. FIG. 7b illustrates the direction of each edge of each branch within every arborescence rooted at MFZS zone B1, illustrating that each of these edges is common to each arborescence rooted in that same root vertex. However, the edges in the core subnetwork [703] are indicated as directionless because, even with a particular root vertex, the directions may differ depending on the particular arborescence.

Because of this commonality, the disclosure focuses on specifying arborescences within core subnetwork [703]. Accordingly, the branch vertex [701](in the example, zone B0) of the source branch (in the example, B) serves as the root vertex of the core arborescence.

Using the arborescences and identification scheme of FIG. 6, two B0 arborescences (i.e., arborescences with root vertex B0) with AS=1 are identified as (D0,1,a) and (B0,1,b). Either of these could be used. In embodiments, a frame initiated at root vertex B1 is duplicated at branch vertex B0 and transmitted on orthogonal arborescences (B0,1,a) and (B0,1,b) within core subnetwork [703]. De-duplication occurs at the receiving branch vertex [701]. For example, for frames destined to MFZS zones in the E branch, deduplication occurs at branch vertex 701e and only non-duplicated frames are sent by branch vertex 701e further into the branch. This limits duplicate frames to core subnetwork [703] and avoids the inefficiency of duplicate frame transmission within the branches.

In embodiments, when a frame transmitted from a source in a branch, such as within exemplary source zone [704], reaches core subnetwork [703], branch vertex [701] makes an arborescence selection for transmission within core subnetwork [703]. In embodiments, the selection of one or more arborescence is made by the branch vertex [701] based on contents of the frame and possibly the ingress port. In embodiments, all selected arborescences are from the same arborescence set and are consequently orthogonal.

In some embodiments, the frame transmitted from a source in a branch arrives at the branch vertex [701] with an explicitly marked arborescence set choice and the branch vertex [701]transmits it accordingly using that arborescence set, with the egress frame identical to the ingress frame. In embodiments, the selection of one or more arborescences, within the marked arborescence set, for transmission is made by the branch vertex [701] based on contents of the frame and possibly the ingress port.

In embodiments, branch vertex [701] selects, for a frame received from a source in its branch, a forwarding arborescence, from among a plurality consistent with a marked arborescence set, based on the destination zones or destination branches to which the frame is intended. For example, in a ring, a divergent zone might select a clockwise or counterclockwise arborescence based on minimizing the routes to the identified destination branches.

In embodiments, a branch vertex selects, for a frame received from a source in its branch, a forwarding arborescence considering a specific arborescence marked in the frame.

In some embodiments, branch vertex [701] selects, for a frame received from a source in its branch, an arborescence for transmission that is not within the arborescence set marked in the ingress frame. In embodiments, branch vertex [701]transmits an egress frame that differs from the ingress frame, reflecting the new arborescence set marking.

In some embodiments, for a frame received from a source in its branch, branch vertex [701] uses information within the frame to determine whether to forward the frame on multiple arborescences. In some embodiments, a frame forwarded to multiple arborescences is modified with respect to the ingress frame; for example, to insert an ordering identifier.

### Destination Zones

The description of frame distribution purely per spanning arborescence within MFZS core zone [204] and throughout the branches is suitable for broadcast frames but is inefficient for multicast, since it distributes frames to each MFZS zone [101] in the MFZS network [201]. For improved efficiency, embodiments forward frames out a port only if destinations of the frame are reachable via that port, while observing the limitations of the selected arborescence.

Embodiments use aspects similar to those of the destination identification process of BIER (“Multicast Using Bit Index Explicit Replication (BIER),” RFC 8279, Internet Engineering Task Force (IETF)). In BIER, a packet carries a destination list, formatted as a bit map in which each bit represents a potential destination in the network and the bit is set to indicate whether or not the packet is intended for that destination. It also supports tables, within BIER switches, that list all the potential destinations associated with each possible next hop of the packet; these are also formatted as bit maps, aligned with the destination list. BIER specifies that the switch computes a binary AND operation of the destination list of the packet and the potential destination list associated with the next hop. If the result is non-zero, then the frame is forwarded toward that next operation, based on the understanding that at least one potential destination is both an identified destination of the packet and also accessible via the route toward that next hop.

MFZS switching in general operates significantly differently from BIER; for example, BIER does not restrict distribution to arborescences. MFZS switching may be more effective and efficient in some circumstances. One notable drawback of BIER is due to the fact that frames are typical revised during the transmission process, and a switch may generate and transmit a custom version of the frame for each next-hop transmission. Generating multiple replicants can be a burden in some switch technologies. In contrast, embodiments of MFZS switching described herein do not require frame alteration within the switch, or, when frame alteration is used (at the source branch vertex [701]), nevertheless emit an identical frame copy at all zone ports where the frame egresses a zone.

In embodiments of MFZS switching, the frame carries a list of the intended destination zones. This list may be determined by the source and embedded into the frame as a destination zone map (DZM). The DZM is an ordered list of bits, one associated with each MFZS zone [101] in the MFZS network [201]. In embodiments, each bit of the frame destination map is set to 1 to indicate that the corresponding MFZS zone [101] is a frame destination, and to 0 otherwise.

In an embodiment, a zone switch [103] maintains, for each branch port [106] within, a list of potential destination zones reachable via that branch port [106], the list in the form of a port zone map (PZM). The PZM is an ordered list of bits, one associated with each MFZS zone [101] in the MFZS network [201], with the order identical to the order of the DZM. In an embodiment, for each branch port [106], zone switch [103] computes a binary AND of the DZM and the PZM. If the result is non-zero, then the frame is included on the lists of ports for which the frame is to be forwarded; otherwise, it is not.

In an embodiment, an MFZS core zone [204], maintains a database identifying forwarding information for a frame based on the source branch (ascertained based on a source branch identifier in the frame), the specified AS (which may be specified per an identifier in the frame), and the ingress port. This forwarding information is recalled in the form of, for each egress port used in the arborescence, a list of potential destination zones reachable via that port, restricted to an identified arborescence. In an embodiment, the list of potential destination zones is in the form of a port zone map (PZM).

A core subnetwork [703] is concerned with delivering a frame to a branch where it is needed, regardless of which destination zones are in that branch. Consequently, in some embodiments, forwarding calculations within a zone switch [103] of a MFZS core zone [204] are compressed by first reducing the DZM to a destination branch map (DBM). The DBM is an ordered list of bits, one associated with each branch [702] in the MFZS network [201]. In such embodiments, the zone switch [103] compares the DBM to a stored port branch map (PBM), which is an ordered list of bits, one associated with each branch [702] in the MFZS network [201], with the order identical to the order of the DBM.

In an embodiment, a zone switch [103] within a branch operates in simplified fashion. Since arborescence discrimination is irrelevant to forwarding within the branch, such a simplified zone switch [103] within a branch does not maintain arborescence-specific forwarding tables but instead forwards on the basis of the DZM and PZM, independent of the frame arborescence.

### Local Delivery

When a particular MFZS zone [101](e.g., zone N) receives a frame whose frame destination map indicates that zone N is a frame destination, zone N forwards the frame toward one or more of station port [107] within zone N. In an embodiment, the frame is forwarded to each such station port [107] within zone N. In other embodiments, the frame is forwarded to a subset of those station ports.

In an embodiment, zone N selects a station port [107] as a delivery destination according to information stored with the frame. In an embodiment, that information includes a stream identifier found within the frame. In an embodiment, each zone switch [103] maintains destination station list (DSL) that lists every station port [107] registered to receive messages assigned to a stream identifier. In some embodiments, a compound stream identifier is considered, wherein the compound stream identifier considers aspects of the frame such as, e.g., source identification.

### Frame Format

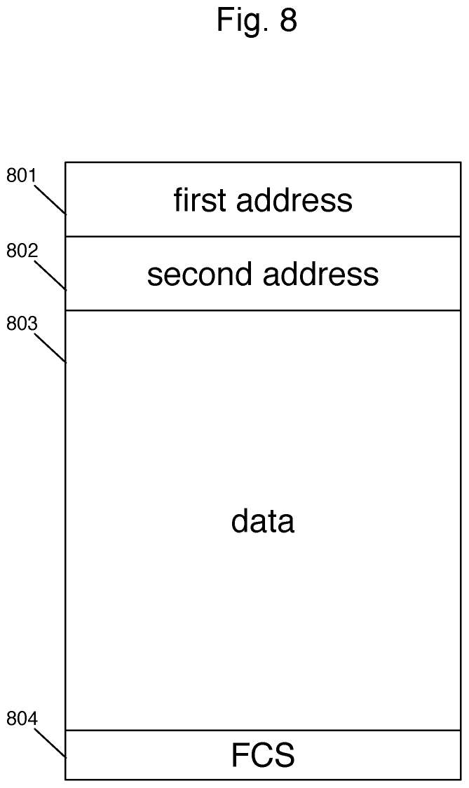

In embodiments of the disclosure, frames share common formatting features. For exemplary purposes, each frame under consideration herein is configured in accordance with the common frame format illustrated in FIG. 8. As illustrated therein, the frame includes a first address field [801], a second address field [802], a data field [803], and an FCS field [804]. For ease of understanding, this example is selected for compatibility with typical Layer 2 networks such as Ethernet, but other embodiments use an alternative frame format.

In an embodiment, the first address field [801] and second address field [802] are of the same fixed length and the data field [803] is of variable length. In an embodiment, the FCS field [804] is of fixed length and provides a checksum, calculated based on the other three fields, that may be used in detecting frame errors. The FCS field [804] is immaterial to the disclosure and may be absent.

In an embodiment representative of typical Ethernet networks, the first address field [801] and second address field [802] are of 6 bytes in length, the FCS field [804] is of 4 bytes in length, the first address field [801] is the first field in the frame, the second address field [802] is the second field in the frame, the data field [803] is the third field in the frame, and the FCS field [804] is the fourth field in the frame.

In conventional Ethernet networks, first address field [801] field holds the address of the frame destination and second address field [802] holds the address of the frame source. In an MFZS network [201], however, the use of these two address fields may, for some frames, vary from convention, as disclosed below.

The discussion below illustrates certain information carried in a frame's first address field [801] and second address field [802]. This exemplifies some way in which such information is carried in some embodiments. Other embodiments carry such information in different fields, such as in data field [803].

### Address Blocks

In embodiments of the disclosure, a zone station [104] may be assigned an Address Block (AB) comprising a set of addresses, wherein the AB is generally in accordance with the description of international patent application PCT/US2021/054450 (“Network block address registration and claiming”). In an embodiment, the AB Address Block is similar to that described in IEEE P802.1CQ/D0.8 (“Draft Standard for Local and Metropolitan Area Networks: Multicast and Local Address Assignment”, 2022 Jul. 31) as a registered address block. While the embodiment using this particular form of address block is useful and practical, the disclosure is to be understood to include other forms of address block with similar general properties.

International patent application PCT/US2021/054450 details address blocks in which the AB set is disjoint in that no address belongs to more than one AB, the AB includes at least one unicast address and at least one multicast address, and the multicast addresses of the AB are determinable from its unicast addresses. Aspects of this disclosure presume these properties of the AB within the MFZS network [201].

International patent application PCT/US2021/054450 details a procedure (“Block Address Registration and Claiming”, or “BARC”) to assign an AB to a station so that it is unique within a network. In some embodiments of the MFZS network [201], an AB may be assigned to a zone station [104] within the MFZS network [201] using BARC. In other embodiments, the assignment is made with a different protocol, or assigned in a configuration process by an administrator. The procedure for the assignment is not material to the disclosure, provided that the assignments are unique within the MFZS network [201]. As a result of that uniqueness, each address that is part of an assigned AB is assigned uniquely within the MFZS network [201].

### First Address Format

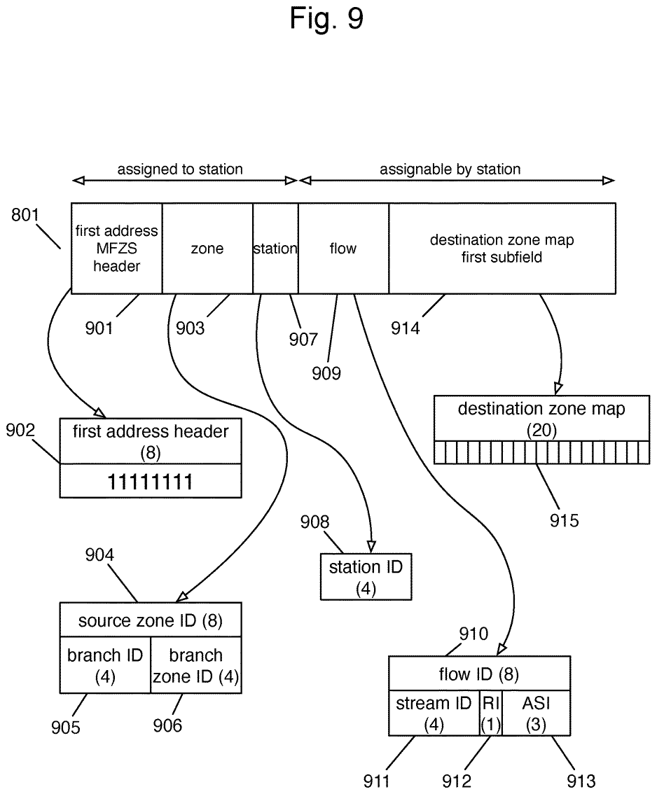

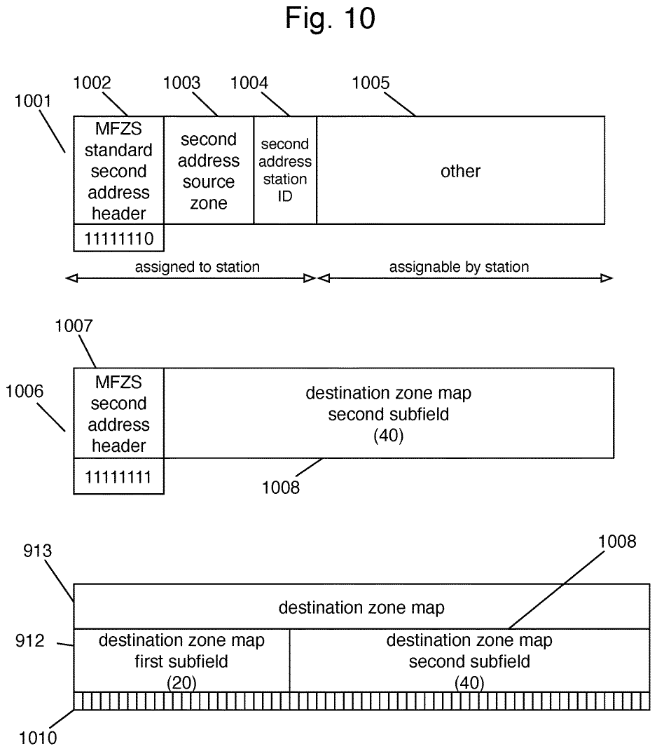

In embodiments, first address field [801] is formatted to include subfields, per FIG. 9. In general, the size and order of the subfields is not material to the disclosure, but the features of the example are convenient for some embodiments.

Per standardization, the first address in the frame identifies the frame destination or destinations. The MFZS first address field [801] follows this standard format.

In embodiments, first address field [801] includes a first address MFZS header [901]. Such a header distinguishes an MFZS frame among frames of other types. An example of a first address MFZS header [901] is illustrated as first address MFZS header example [902]. The example is eight bits long, and each bit is 1. This is consistent with previous disclosures, such as International patent application PCT/US2021/054450. The rightmost bit represents the least-significant bit and, per existing standardization, is set to 1 to indicate that the address is a multicast address. In some embodiments, the remainder of the bits, in addition to distinguishing the frame as an MFZS frame, may indicate the detailed format of the remainder of first address field [801], including subfield sizes and locations, such as when mixtures of different formats may be used.

In embodiments, first address field [801] includes a zone subfield [903]. In embodiments, zone subfield [903] takes the form of source zone ID [904] that carries an identifier that identifies the source zone of the MFZS frame uniquely within MFZS network [201]. In embodiments, source zone ID [904] is subdivided into two subfields, expressing the branch ID [905] and branch zone ID [906], respectively. In embodiments, branch ID [905] is assigned as a unique identifier of a branch, and branch zone ID [906] values are assigned uniquely to identify zones within the branch, so that each MFZS zone [101] has a source zone ID [904] unique throughout MFZS network [201]. The example in the figure, with four bits for each of branch ID [905] and branch zone ID [906] subfields, allows for 16 branches and 16 zones per branch. Even if other considerations limit the total number of zones, this allows for flexibility in case the zones are not equally distributed among the branches. Again, all parenthetical subfield sizes in the figure are exemplary.

In embodiments, first address field [801] includes a station subfield [907]. In embodiments, station subfield [907] contains a station ID [908] that identifies the source station of the frame. In embodiments, a station ID [908] assignment is unique to each zone station [104] within MFZS zone [101], so the combination of source zone ID [904] and station ID [908] identifies the source station uniquely within MFZS network [201].

International patent application PCT/US2021/054450 details how an AB is assigned to a network device so that the assignment is represented in a fixed set of bits in the initial segment of the address, with the remaining bits all “wild-card” bits that are assignable by the network device holding the assignment. In accordance with that disclosure, embodiments operate with the first three fields of first address field [801](namely, first address MFZS header [901], source zone ID [904], and station ID [908]) assigned uniquely to a zone station [104]. These MFZS frames transmitted by the source station are drawn from the set of multicast addresses within the AB assigned to that station and thereby carry a source zone ID [904] that (among frames with the assigned first address MFZS header [901]) uniquely identifies the MFZS zone [101] and branch [702] of the source station; furthermore, they carry a unique (among frames with the assigned first address MFZS header [901]) identifier of the source station through the combination of source zone ID [904] and station ID [908]).

In embodiments, the zone station [104] thus has access to a set of multicast address that it can assign without the possibility of duplication with addresses used by another zone station [104]. In embodiments, these station-assignable bits are structured so that other network elements can understand the semantics.

In embodiments, first address field [801] includes a flow field [909]. In some embodiments, flow field [909] contains flow ID [910] and is divided into subfields containing stream ID [911], Redundancy Indicator (RI subfield [912]), and Arborescence Set Indicator (ASI subfield [913]).

In some embodiments, stream ID [911] is commonly assigned by zone station [104] to a sequence of frames. Some embodiments apply stream ID [911] to arrange for frames from a common zone station [104] and sharing a common stream ID [911] to be routed to follow a common path in order to preclude misordering among the sequence. In some embodiments, a destination MFZS zone [101] uses the stream ID [911] in the determination of frame forwarding.

In embodiments, RI subfield [912] and ASI subfield [913] are set by the station in order to indicate the station's arborescence preference for the frame. In embodiments, a branch vertex that receives a frame originating in its branch may make an arborescence selection in accordance with the ASI subfield [913] and RI subfield [912] and replace the contents of those subfields with indications of the selection.

In embodiments, the station may set RI subfield [912] to 0 and set ASI subfield [913] to indicate a request for a quantity of arborescences to be assigned by the branch vertex. In those cases, the station may set the ASI subfield [913] to indicate a number larger than 1 for frames that demand high delivery reliability or low delivery latency. In embodiments, the station may set the ASI subfield [913] to a particular value indicate that the arborescence of the frame is arbitrary.

In embodiments, the station may set RI subfield [912] to 1 and set ASI subfield [913] to indicate a request for a particular arborescence set to be assigned by the branch vertex.

In embodiments, ASI subfield [913] is reset by a bridge vertex to indicate the arborescence set to which a frame is assigned, as described below.

In embodiments, RI subfield [912] is reset by a bridge vertex as an indication of a frame arborescence duplication; for example, to 1 for a frame being duplicated on multiple arborescences within an arborescence set and to 0 as an indication of a frame not being duplicated.

In embodiments, the destination zone map first subfield [914] contains a destination zone map (DZM), as exemplified by DZM [915]. DZM [915] is an ordered set of bits in which each bit represents an MFZS zone [101] in MFZS network [201]. The destination zone map first subfield [914] lies in the portion of the first address field [801] that is assignable within the source zone initiating the frame. In some embodiments, the source zone assigns a bit value as 1 if, and only if, the MFZS zone represented by that bit is an intended destination of the frame.

In the example of FIG. 9, DZM [915] includes 20 bits and can therefore represent up to 20 MFZS zones in MFZS network [201]. Further information on DZM [915], including an expansion to support additional MFZS zones, is provided below.

### Second Address Format

In embodiments, second address field [802] is formatted to include subfields, per FIG. 10. In general, the size and order of the subfields is not material to the disclosure, but the features of the example are convenient for some embodiments.

Per standardization, the second address in the frame identifies the frame source. The MFZS second address field [802] does not necessarily follow this standard.

In embodiments, second address field [802] is formatted in accordance with standards. International patent application PCT/US2021/054450 describes how the AB includes both unicast and multicast address, with identical bits in the initial part of the address, fixed per assignment. Accordingly, the standard second address [1001] begins with the MFZS standard second address header [1002] field followed by the second address source zone [1003] and second address station ID [1004]. These fields are nearly identical to the corresponding fields of the AB-derived first address field [801] of FIG. 9, since the source address of a frame originating at zone station [104] is drawn from the same AB as that reflected in first address field [801]. The contents of the zone subfield [903] and the second address source zone [1003] are therefore identical, as are the station ID [908] and the second address station ID [1004]. The MFZS standard second address header [1002] differs from the first address MFZS header [901] only in the rightmost (least significant) bit. Per standardization, this bit is set to 0 in the MFZS standard second address header [1002] because the source address is, per standardization, a unicast address assigned to the source. In embodiments, the remainder of standard second address [1001] is selected by the source MFZS zone [101]. This remainder, identified in the example as other field [1005], is used for various purposes, depending on the embodiment.

In other embodiments, second address field [802] is formatted not in accordance with standards but instead as MFZS second address [1006] that does not explicitly represent a unicast address associated with the frame source. Since the source of the MFZS frame can be identified from first address field [801] as needed, identification of the source in second address field [802] is redundant. For example, some embodiments begin MFZS second address [1006] with MFZS second address header [1007] that differs from MFZS standard second address header [1002] by setting the least significant bit to 1, indicative (per standards) of a multicast address. In some embodiments, this serves to alert learning bridges that the address is not a conventional source address and that the learning bridge should not attempt to learn this second address. In some embodiments, this serves to alert learning bridges that the learning bridge should learn not the explicit second address but should instead learn to associate the ingress port with the direction toward the AB (identified in source zone ID [904] and station ID [908]) from which the first address field [801] is drawn.

In embodiments, the remainder of MFZS second address [1006] serves as an extension of the DZM [915] described in regards to FIG. 9. In the embodiment illustrated in FIG. 10, DZM [915] is enlarged to include both destination zone map first subfield [914] and destination zone map second subfield [1008]. In the illustrated example, the former includes 20 bits and the latter 40 bits. This example DZM supports the identification of up to 60 destination MFZS zones in the frame.

In some embodiments, DZM [915] is contained entirely within second address field [802]. In some embodiments, some or all DZM [915] is included elsewhere in the frame, outside of first address field [801] and second address field [802].

### Port Zone Map (PZM)

In embodiments of MFZS switching, the frame carries a list of the intended destination zones. This list may be determined by the source and embedded into the frame as a destination zone map (DZM [915]). The DZM [915] is an ordered list of bits, one associated with each MFZS zone [101] in the MFZS network [201]. Each bit of DZM [915] is set to 1 to indicate that the corresponding MFZS zone [101] is a frame destination, and to 0 otherwise.

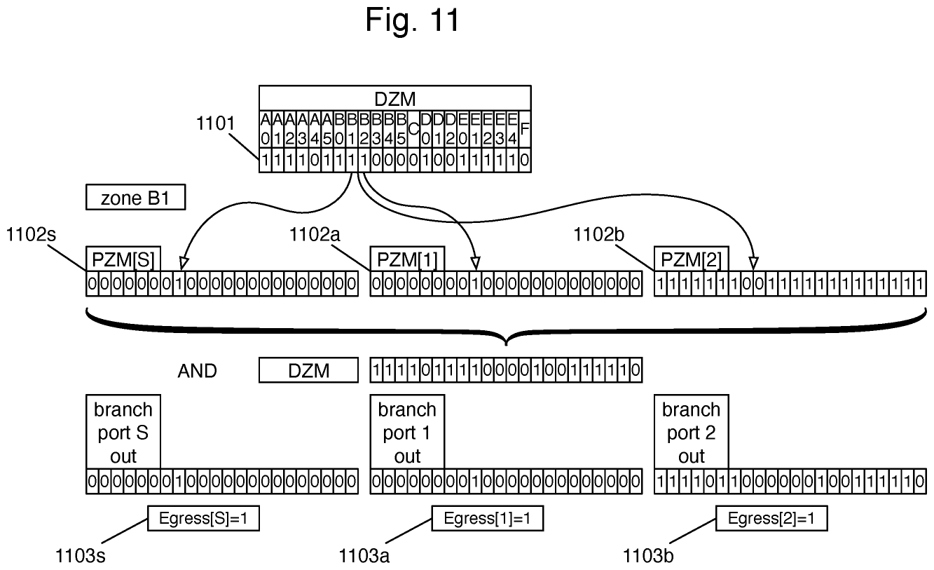

FIG. 11 illustrates a DZM [1101]. The example is constructed according the example of network of FIG. 7a, and each bit of the DZM [1101] is accordingly labeled, for explanatory purposes, with the identifier of an MFZS zone [101] from FIG. 7a. The order in which the MFZS zones are represented may be immaterial, as long as the order is commonly recognized by each MFZS zone [101]. In the example, some but not all MFZS zones of the network are listed as destinations.

In an embodiment, a zone switch [103] in a branch maintains a port zone map (PZM[i]) for each branch port [106] i and for a virtual branch port, referred to herein as Port S, that represents one or more instance of a local station port [107]. PZM[i] specifies a list of zones reachable via branch port i. For MFZS zone j, the only MFZS zone reachable by Port S is the local zone j.

In an embodiment, the list of zones in the PZM is in the form of an ordered list of bits, one bit associated with each MFZS zone [101] in the MFZS network [201], with the order identical to the order of the DZM, and each bit of PZM[i] is set to 1 if and only if the associated MFZS zone [101] is reachable via branch port i.

Examples of PZM [1102] are illustrated in FIG. 11, applicable to MFZS zone B1 of FIG. 7a. All of the ports of zone B1 are branch ports, so the PZM comprises three elements: PZM[S], PZM[1], and PZM[2]. There are illustrated as PZM 1102s (PZM[S], for Port S), PZM 1102a (PZM[1], for port 1), and PZM 1102b (PZM[2], for port 2). The figure illustrates, by an arrowed curve, the relationship between the zone indicator in the DZM [915] and the corresponding zone indicator in the PZM[i]. Since the only MFZS zone reachable by Port S is the local zone B1, all bits of PZM[S] are 0 except the one associated with zone B1 itself. For PZM[1], all bits are 0 except the one indicating B2; as seen in the figure, B2 is the only zone reachable via port 1. For PZM[2], all bits except the ones indicating B1 or B2 are 1; as seen in the figure, those are all reachable via port 2.

In an embodiment, zone switch [103], upon receipt of a frame, computes a bitwise AND of PZM[i] and the frame's DZM for each branch port i. The result indicates which MFZS zones are both destinations of the frame (as identified in the DZM) and also reachable by that branch port (as identified in PZM[i]). The frame is forwarded out that branch port if and only if the result is non-zero; in other words, if some destination zone is reachable via that branch port. In some embodiments, an Egress vector [1103] is prepared, setting the value of Egress[i], for each branch port, per Egress[i]=(PZM[i]&DZM≠0), where “&” represents the bitwise AND operation and, throughout, a vector is considered “≠0” or nonzero if and only if one of its elements is nonzero. FIG. 11 illustrates the values of PZM[S]&DZM, PZM[1]&DZM, and PZM[2]&DZM. It also illustrates that consequently Egress[S](1103s)=1 (because B1 is a destination at Port S, Egress[1](1103a)=1 (because B2 is a destination at port 1), and Egress[2](1103b)=1 (because several zones are destinations at port 2).

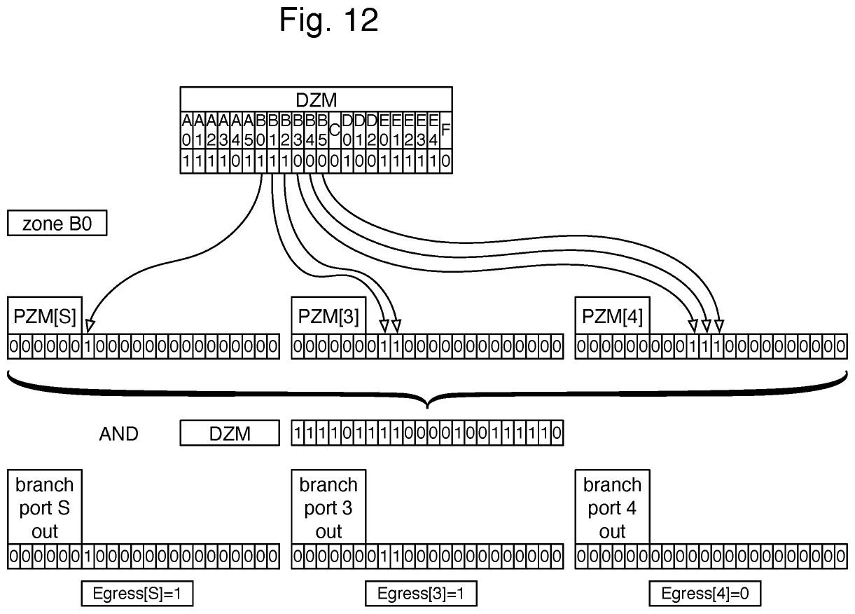

FIG. 12 provides a similar illustration but where the MFZS zone is a branch vertex; in particular, zone B0 of FIG. 7a. Port 1 and 2 of zone B0 are not branch ports since they lead outside of branch B. Hence, PZM[i] is specified only for ports S, 3, and 4. As shown, PZM[S] identifies only the local zone (zone D0). PZM[3] identifies only zones B1 and B2, since those are the only zones on the subbranch at port 3. Likewise, PZM[4] identifies only zones B3, B4, and B5, since those are the only zones on the subbranch at port 4. The values of the Egress vector are also shown, with the same DZM [1101] as FIG. 11. Note that Egress[4]=0 because the example DZM [1101] indicates no destinations in zones B3, B4, and B5.

### Inter-Branch Forwarding

The PZM [1102] is specified at branch ports. Embodiments use procedures to make port forwarding decisions for inter-branch forwarding. Forwarding among branches makes use of a core port [105].

### Destination Branch Map (DBM)

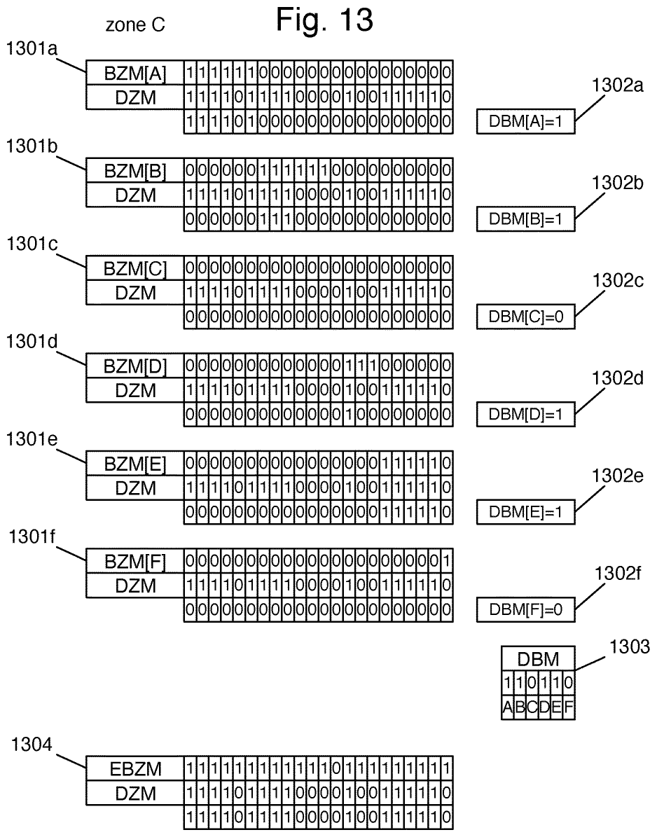

In embodiments, a branch vertex receiving a frame determines which branches, outside its own, contain destination zones. Some embodiments extract a destination branch map (DBM [1303]) from the DZM [915]. An example is provided in FIG. 13. In an embodiment, the method uses a stored branch zone map (BZM [1301]) for each branch. For each branch n, BZM[n] is an ordered bit set, following the order used by the DZM [915], that indicates whether the MFZS zone associated with the bit is located within branch n. In the example of FIG. 13, which illustrates zone C in the network of FIG. 7a, BZM[A]-BZM[F] is shown in 1301a-1301f, respectively. As shown, each bit position is 1 if and only if the zone associated with that bit position is found within BZM[n]. Exceptionally, however, BZM[n] is set to all 0 values within zone n. In other words, in all zones m, the stored BZM[n] is identical, except that, in each case, BZM[n] is entirely 0 for zone n. This ensures that forwarding to a zone within the local branch is not considered a case of inter-branch forwarding.

As illustrated in FIG. 13, DBM [1303] is a vector, each of whose elements DBM[n] is a DBM branch indicator [1302]. DBM[n] is calculated as DBM[n]=(BZM[n]&DZM #0); that is, DBM[n] is 1 unless every bit of the bitwise AND of BZM[n] and DZM is 0. As a result, DBM[n] is 1 if and only if DZM includes an inter-branch destination within branch n. FIG. 13 provides an example of this calculation for the example BZM values (reflecting the example of FIG. 7a) and the example DZM used in FIG. 11 and FIG. 12. In the example, DBM[F] is 0 because DZM indicates no destinations in zone F. DBM[C] is 0 because BZM[C] is 0, because the example provided regards MFZS zone C.

### Inter-Branch Frame Identification

In some embodiments, the branch vertex computes DBM [1303] from a received frame. If DBM=0, then the frame has identified no inter-branch destinations and no interbranch forwarding is applied. If DBM #0, then the frame is identified as an inter-branch frame, and inter-branch forwarding procedures are invoked.

In some embodiments, the branch vertex first uses an external branch zone map EBZM [1304] to determine, with a single bitwise AND, whether any inter-branch destinations are present and inter-branch forwarding procedures are needed. The EBZM [1304] is a single stored ordered bit set with a 1 for each external destination zone. If EBZM&DZM≠0, then the frame is identified as an inter-branch frame, and inter-branch forwarding procedures are invoked.

### Arborescence Assignment for Inter-Branch Forwarding

In embodiments, the branch vertex makes an arborescence selection, from among the arborescences with a root at the branch vertex, for inter-branch frames received from within its branch (i.e., from a branch port [106] of that branch vertex) in considerations of factors that may include:
any elements of the frame;
the branch port [106] at which the frame was received by the branch vertex;
the RI subfield [912] and ASI subfield [913] of the frame's first address field [801], which may have been assigned at the source to indicate, for example, an arborescence set preference or a preferred number of arborescences;
a flow identifier, such as that comprising the source zone ID [904], the station ID [908], and the stream ID [911];
the frame destinations, as expressed in the frame's DZM [915] and/or DBM [1303];
the current state of the network and its traffic, such as the output queues of the zone switch [103]; and
the possible need to ensure that a series of frames that make up a flow all follow the same path, to avoid misordering at the destination.

For example, the branch vertex may assess a frame priority based on various elements of the frame and then assign an arborescence based on that priority. For example, the priority assessment could consider the number of destinations or the priorities of the specific destinations, considering, for example, how the expected latency to those destinations would depend on the choice of arborescence. In embodiments, the priority assessment considers source-related aspects of the frame.

In some embodiments, the branch vertex may select multiple arborescences from different arborescence sets. However, since the selected arborescence set is marked in the frame with ASI subfield [913], such embodiments require the generations of multiple variations of the frame. The presentation herein avoids this complication by presuming that multiple arborescences, if used, are all drawn from the same set.

Accordingly, the branch vertex assigns its selected AS [502] accordingly, modifying the ASI subfield [913] of the frame as necessary to match that assignment. The branch vertex may modify the RI subfield [912] as necessary so that the field will contain 0 if only a single arborescence is selected and 1 if multiple arborescences are selected.

### Port Branch Map (PBM)

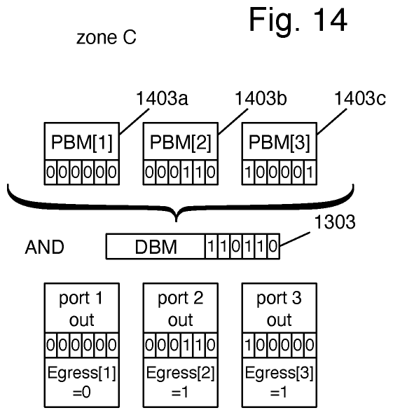

Once a frame has been forwarded to its branch vertex, it is forwarded through the core subnetwork [703] in accordance with an arborescence selection and the DZM. In order to reduce the amount of forwarding data stored, some embodiments make forwarding decisions by comparing the destination branch map (DBM [1303]) to port branch map (PBM [1401]) rather than by comparing the DZM to a PZM [1102]. An example is provided in FIG. 14.

Because DBM [1303] indicates branch destinations rather than zone destinations, it is compared to a port's PBM [1401] rather than to PZM [1102] in order to determine whether frames to the identified branch destinations should be sent to a port. PBM[i] is an ordered set of bits, each representing a branch, in the same order as the bits of DBM [1303], each such bit indicating whether a frame to the identified branch should be sent via core port i. Examples are illustrated in FIG. 14, for the configuration of FIG. 7a and FIG. 7b and for branch vertex C, where ports 1, 2, and 3 are all core ports. Examples of PBM[1], PBM[2], and PBM[3] are shown in the figure.

In embodiments, consideration of the frame's DBM and PBM[i] for port i determines whether the frame will be transmitted via port i. This may be enacted by recording a value Egress[i] of the Egress vector, using Egress[i]=(PBM[i]&DBM≠0); that is, Egress[i] is 1 unless every bit of the bitwise AND of PBM[i] and DBM is 0. In the example of FIG. 13, Egress[1]=0 and the frame is forward to ports 2 and 3 only, not to port 1.

Typically, PZM [1102] is dependent only on the configuration of the network and does not vary unless the network configuration changes. In contrast, PBM [1401] is typically dependent on the arborescence, which may vary from frame to frame. The example above uses the “(B,1,a)” arborescence of FIG. 6. For information on how PBM[i] may be determined, see below.

### Source Branch Identification

As discussed above, an arborescence has a root vertex. Identifying the arborescence of a frame requires identifying the root vertex of the frame. The root vertex of an arborescence among the core zones is the branch vertex, which has a one-to-one relationship with the frame source branch. Identifying the source branch may be necessary to identify the arborescence. In some embodiments, the source branch is not explicitly embedded in the frame.

As shown in FIG. 9, source zone ID [904] may be explicitly identified in the frame's first address field [801]. Some embodiments divide the source zone ID [904] into the branch ID [905] and the branch zone ID [906], with the branch ID [905] explicitly identifying the branch. In some embodiments, the source branch is identified from the content of the branch ID [905] field.

Alternatively, as shown in FIG. 13, BZM [1301] contains information relating the zones to their branches. In particular, BZM[N] identifies the zones of branch N. Some embodiments identify the source zone ID [904] from a frame, determine from that source zone ID [904] the associated bit position j in the DZM (and therefore in the BZM) associated with that zone, and then determine the frame's source branch as the value of N such that bit j in BZM[N] is 1. For example, in some embodiments, the zone IDs are assigned to zones in consecutive order and the zones are assigned to the DZM in the same order; as a particular example, the zone ID values may be 1, 2, etc. and the DZM bit assignments may be such that bit 1 represents zone 1, bit 1 represents zone 1, etc. In that case, this method may be particularly practical. Other methods of identifying the source branch can be implemented in other embodiments.

The presentation below refers to the identifier of the source branch (the branch ID [905] field of the frame, or an equivalent identifier) as the source branch ID.

### PBM Lookup

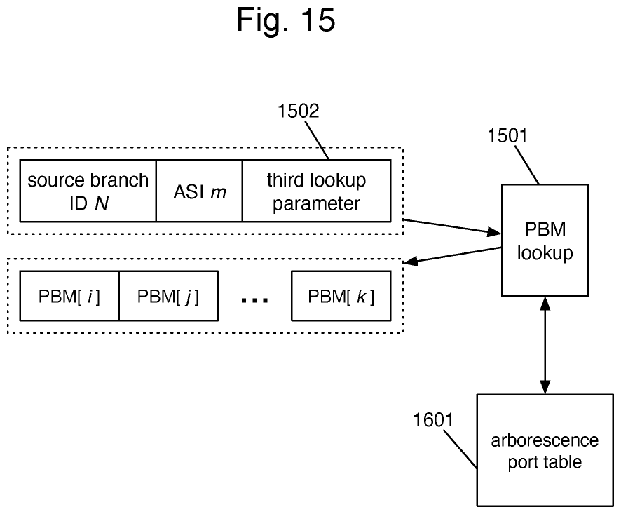

In embodiments, the PBM for each core port [105] is determined using a PBM lookup [1501], as illustrated in FIG. 15. PBM lookup [1501] is called with two parameters (source branch ID and ASI subfield [913]) determined based on the frame content and (when identifying orthogonal arborescences with a common ASI subfield [913]) a third lookup parameter [1502] to distinguish among them. When the frame arrives at the MFZS core zone [204] from a branch port [106], the MFZS core zone [204] selects the arborescence and therefore knows the distinguishing AT [503], which it uses as third lookup parameter [1502]. When the frame arrives at the MFZS core zone [204] from a core port [105], the MFZS core zone [204] identifies the ASI subfield [913]) from the frame. Since it cannot generally determine the AT [503] directly, it uses, as third lookup parameter [1502], the frame ingress port ID [115] determined as metadata associated with the receipt of the frame by zone switch [103]. Based on that input data, FIG. 15 returns a PBM[I] for each core port [105] I of the zone switch [103] of the MFZS core zone [204]. PBM lookup [1501] may refer to arborescence port table [1601].

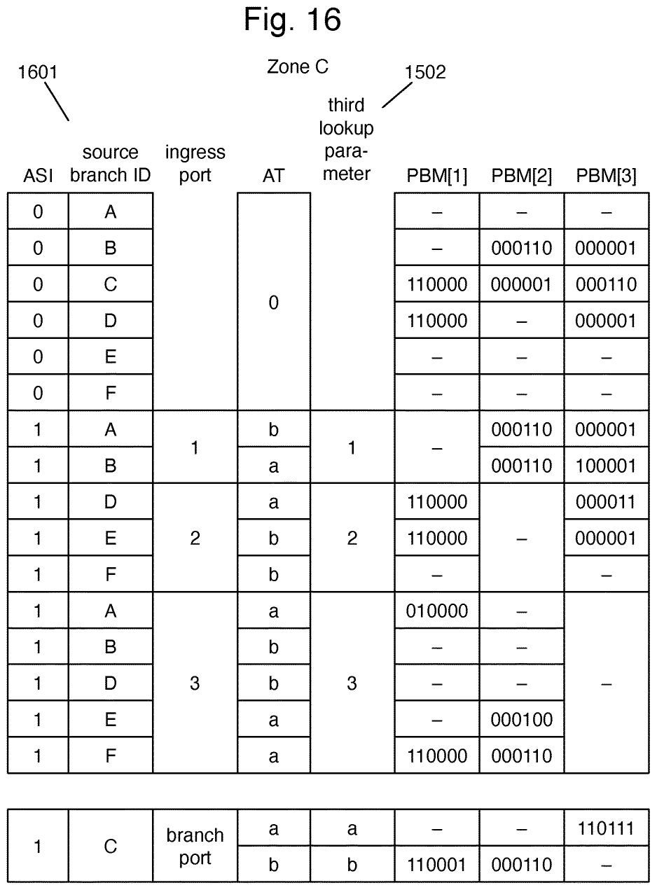

FIG. 16 illustrates how embodiments implement PBM lookup [1501] use an arborescence port table [1601](APT). In FIG. 16, a hyphen in a table cell indicates no forwarding from that cell; this is logically equivalent to PBM bits that are all 0 but may be stored more efficiently. The example applies to zone C of FIG. 7a. Three arborescence sets of FIG. 6 are fully exemplified: one in AS 0 and two (AT=a and AT=b) of AS 1.

The ASI=0 entries are independent of ingress port since the ASI=0 arborescence set includes only a single arborescence. In the case of AS 0, one row of the table is provided for each source branch ID; the ASI and the source branch ID together designate the arborescence, and the resulting values of PBM[I] are provided as the output of PBM lookup [1501], where I includes each core port [105] of zone C. For ASI=0, the A, E, and F arborescences all terminate at zone C, as shown in FIG. 6, so all those PBMs are empty. The B and D arborescences are both enabled to forward to two ports, depending on the DBM. The C arborescence is enabled to forward to three ports, depending on the DBM.

The ASI=1 entries of FIG. 16 depend on third lookup parameter [1502], which distinguishes among the two arborescences of the set. Combinations of branch ID and third lookup parameter [1502] not shown are inconsistent with the arborescence set.

When the source branch ID is A, B, D, E, or F, it is outside the MFZS core zone [204] and third lookup parameter [1502] is ingress port ID [115]. For clarity, FIG. 16 shows the AT [503] in these cases, though the PBM lookup [1501] need not have access to this information. The diagonal entries of this portion of the table (where the egress port matches the ingress port) are blank, since frames are never forwarded back via the ingress port.

When the source branch ID is C, the MFZS core zone [204] knows AT [503] and uses it as third lookup parameter [1502].

FIG. 14 illustrated forwarding based on an identified PBM set in zone C, considering a frame from the B branch. The PBM values in that example match those illustrated in FIG. 16 for the relevant ASI (1), in which the frame arrived at zone C (from zone B) via its port 1. As shown in that example, the PBM selection enables the zone C zone switch [103] to forward the frame from both ports 2 and 3; however, unless the DZM indicates suitable destinations ahead (zone D or zone E for port 2; zone A or zone F for port 3), then the frame will be forwarded on one port or not forwarded at all.

### Station Port Lookup

As explained in accordance with FIG. 11 and FIG. 12, Port S is used herein as the identifier of a virtual branch port that represents one or more instance of a local station port [107]. If, in accordance with processing an ingress frame, the Egress vector is determined such that Egress[S]=1, then the frame (herein called a station egress frame) is designated to be forwarded to one or more instance of a local station port [107].

In some embodiments, a station egress frame is forwarded to each station port [107] in the MFZS zone [101]. However, as described earlier, such a result is nonideal in some networks.

In some embodiments, a station egress frame of MFZS zone [101] is processed to determine station ports for forwarding. During processing, the Egress vector value Egress[i] is set to 1 for a station port [107] in the MFZS zone [101] if and only if determination is made to forward the egress frame to port i.

In an embodiment, zone switch [103] selects a station port [107] as a delivery destination according to information stored with the frame. In an embodiment, that information includes a flow designation found within the frame. In an embodiment, each zone switch [103] maintains destination station list (DSL) that lists every station port [107] to receive messages assigned to a flow designation, for a variety of flow designations. In an embodiment, the flow designation comprises the frame's source zone ID [904] and elements of its flow ID [910].

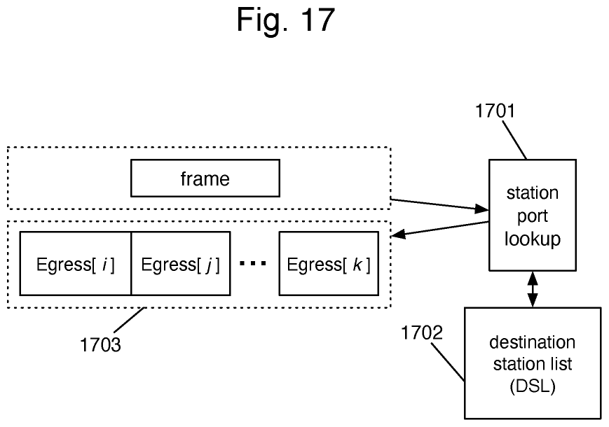

FIG. 17 illustrates an embodiment of station port lookup [1701]. The station port lookup [1701] process accepts, as input, a frame, or elements of a frame.

In some embodiments, the process responds by setting the value of Egress[i], for each station port i, to 1 for an egress frame at port i.

In embodiments, station port lookup [1701] considers characteristics of the frame's first address field [801], such as source zone ID [904], station ID [908], and flow ID [910]. In embodiments, station port lookup [1701] operates by searching DSL [1702].

In embodiments, station port lookup [1701] considers characteristics of the frame's first address field [801], such as source zone ID [904], station ID [908], and flow ID [910].

### Frame Egress

In embodiments, zone switch [103], following receipt of ingress frame [113] and determination of a resulting Egress vector, forwards, as egress frame [114], a copy of the frame for egress at each port i such that Egress[i]=1. However, in some cases, transmission out the egress port is deferred pending deduplication and reordering, such as in cases in which duplicate copies of a frame are anticipated due to the use of multiple arborescences.

In embodiments, egress frame [114] is identical to ingress frame [113]. In embodiments, egress frame [114] is identical to ingress frame [113] except for minor changes unrelated to MFZS operation.

In embodiments, egress frame [114] may differ from ingress frame [113] regarding RI subfield [912] and ASI subfield [913]; for example, if MFZS zone [101] is an MFZS core zone [204] and ingress frame [113] arrived at MFZS core zone [204] directly from an MFZS branch zone [203] or a zone station [104].

### Forwarding Procedure

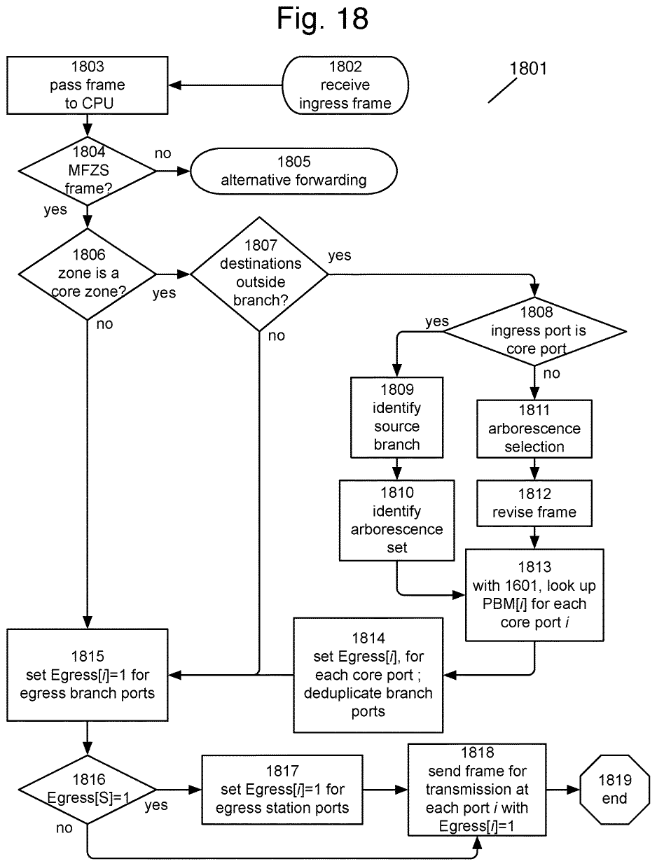

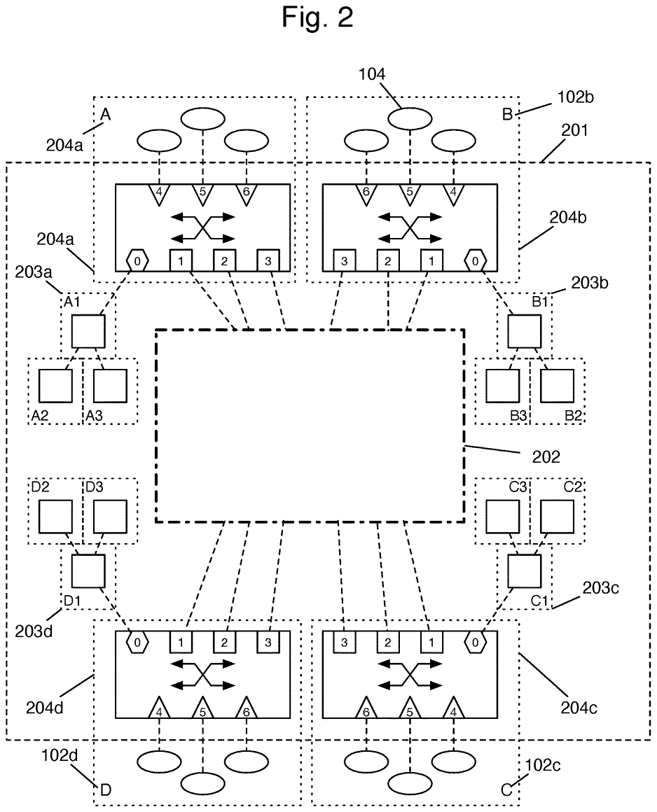

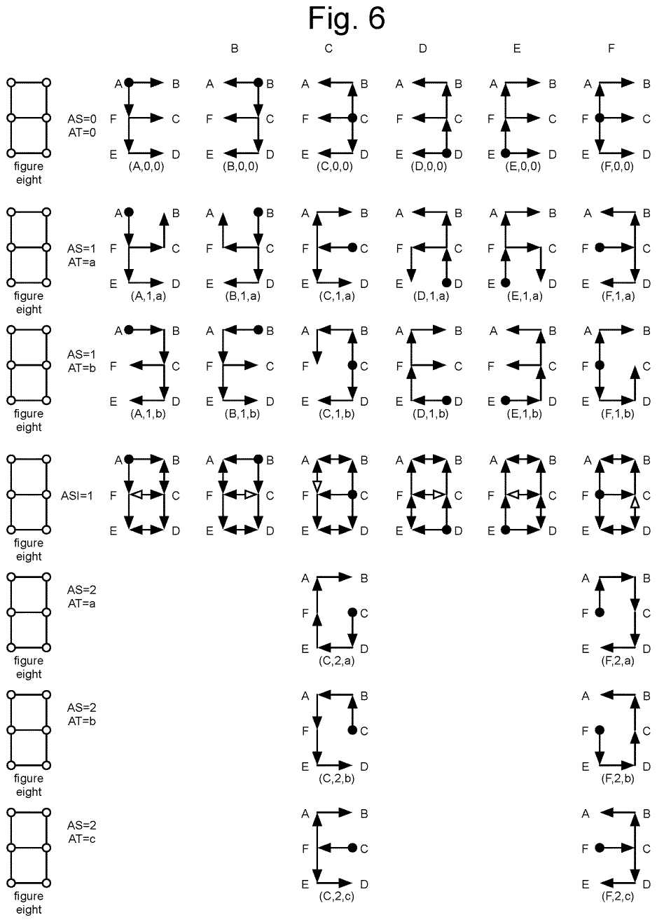

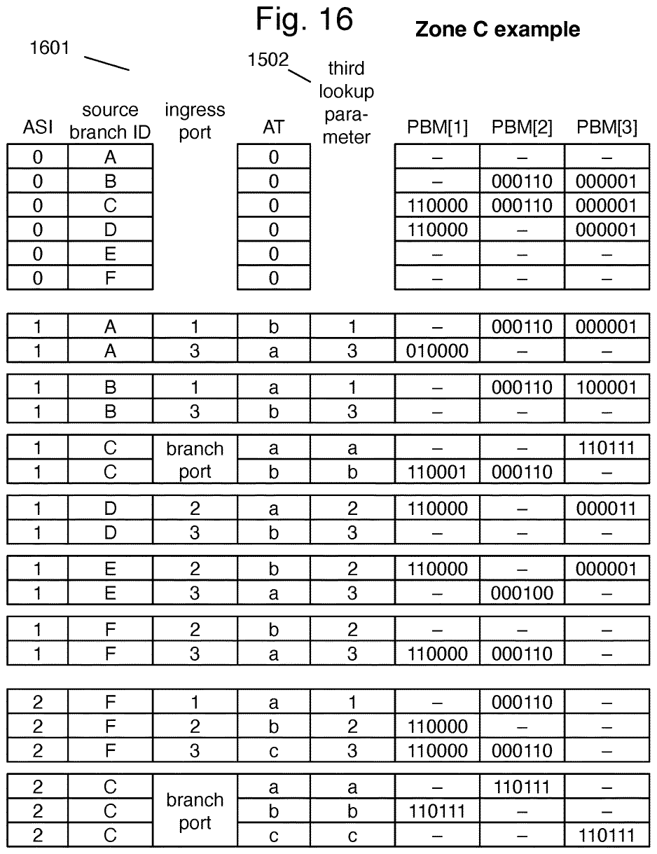

In an embodiment, an operation of zone switch [103] in MFZS zone [101](either MFZS core zone [204] or MFZS branch zone [203]), to forward the contents of MFZS ingress frame [113] as one or more copies of egress frame [114] is illustrated in MFZS forwarding procedure [1801] of FIG. 18, with steps as follows.

In Step [1802], zone switch [103] receives ingress frame [113] at an ingress port.

In Step [1803], ingress frame [113] is passed to processor [111] for processing, along with the ingress port ID [115] of the ingress port. The processor [111] initializes Egress vector [1103] of ingress frame [113], setting it to 0.

In Step [1804], processor [111] examines ingress frame [113], determining whether it is an MFZS frame by, for example, detecting MFZS-specific first address MFZS header [901] within first address field [801]. If so, then Step [1806] follows. If not, then Step [1805] follows.

In Step [1805], alternative forwarding methods, not based on MFZS, are invoked and MFZS forwarding procedure [1801] ends.

In Step [1806], if MFZS zone [101] is a MFZS core zone [204], then step Step [1807] follows. If not, then Step [1815] follows.

In Step [1807], processor [111] determines whether any destinations of the frame lie outside the branch of its MFZS zone [101]. If so, then Step [1811] follows; if not, then Step [1815] follows. Such inter-branch destinations may be indicated, for example, if EBZM[i]&DZM≠0, where EBZM [1304] is recalled from memory [112]. Step [1808] ensues.

In Step [1808], if processor [111] identifies the ingress port ID [115] as a core port ID [108], then Step [1809] ensues; otherwise, Step [1811] ensues.

In Step [1809], processor [111] identifies the source branch of ingress frame [113], determining the source branch ID. This may, for example, entail reading the branch zone ID [906] from first address field [801] of the parsed ingress frame [113]. Step [1810] ensues.

In Step [1810], processor [111] identifies the arborescence set of the ingress frame [113], by for example, reading the ASI subfield [913] of the parsed ingress frame [113] such that the arborescence set is identified by its source branch ID and ASI subfield [913]. Step [1813] ensues.

In Step [1811], processor [111] selects an arborescence set (with root vertex at the local zone of zone switch [103]) and makes, from within that set, an arborescence selection for forwarding the frame, considering factors that may include the content of ingress frame [113]; the content of first address field [801] and second address field [802]; the content of ASI subfield [913]; the ingress port ID [115] of the port at which ingress frame [113] was received; and the current state of the network and its traffic. The frame may be assigned to one or more arborescence in the arborescence set. Step [1812] ensues.

In Step [1812], processor [111] may revise ingress frame [113], editing the ASI subfield [913] as necessary to indicate the selected arborescence set, setting the value of RI subfield [912] to 0 if a single arborescence is selected and to 1 if multiple arborescences are selected. The frame may be further altered, for example, to include sequence numbering information. In case of revision, references to ingress frame [113] in following steps of MFZS forwarding procedure [1801] refer to ingress frame [113] as revised in this step. Step [1813] ensues.

In Step [1813], processor [111] determines the PBM[i] for each core port i. Some embodiments identify those PBM[i] using PBM lookup [1501] based on arborescence port table [1601], stored in memory [112]. The lookup parameters are the ASI subfield [913](as found in Step [1810] or determined in Step [1811]) the source branch ID (as found in Step [1809] or determined as the branch of zone switch [103] if the path of Step [1811]) was taken, and the third lookup parameter (either the ingress port, or, if the path of Step [1811] was taken, the selected AT [503]). The third lookup parameter is unneeded if the arborescence set includes only a single arborescence. If the path of Step [1811]) was taken and more than one arborescence was selected, then arborescence port table [1601] is repeated for each selected arborescence and each resulting single-arborescence PBM[i] is combined with a bitwise OR function to attain a complete PBM[i], so that forwarding will take place for destinations along any of the selected arborescences. For example, in the table of FIG. 16 with source branch ID C and ASI=1, PBM[1] and PBM[2] would be those of AT=b, while PBM[3] would be that of AT=a. Step [1814] ensues.

In Step [1814], processor [111] sets elements Egress[i] of Egress vector [1103] for each core port i to indicate whether an egress frame should be transmitted at the port. For example, it may set Egress[i] according to the formula Egress[i]=(PBM[i]&DBM≠0), where DBM is the DBM [1303] computed from DZM [915] using BZM [1301] records stored in memory [112]. For egress ports that are branch ports, de-duplication may also occur in this step. For example, if a copy of ingress frame [113] from a different arborescence has already been transmitted to the branch port, suppression of the duplicate may be achieved by overwriting Egress[i] to 0. Frame resequencing and editing (for example, to remove sequence indicators) could also be performed in this step. Step [1815] ensues.

In Step [1815], processor [111] sets element Egress[i] of Egress vector [1103] to 1 for each branch port [106]i at which an egress frame should be transmitted. For example, it may set Egress[i] according to the formula Egress[i]=(PZM[i]&DZM #0), where PZM[i], stored in memory [112], identifies the local branch zones reachable via branch port i. In addition, Port S is used herein as the identifier of a virtual branch port that represents one or more instance of a local station port [107]. Step [1816] ensues.

If Egress[S]=1, then Step [1817] follows Step [1816]. Otherwise, Step [1818] follows Step [1816].

In Step [1817], processor [111], for each instance i of station port [107], sets element Egress[i] of Egress vector [1103] to 1 if egress frame [114] should be transmitted at station port i. Some embodiments select those egress station ports using station port lookup [1701] based on DSL [1702], stored in memory [112]. Step [1818] ensues.

In Step [1818], processor [111] queues ingress frame [113] for transmission at each port i for which Egress[i]=1.

In Step [1819], MFZS forwarding procedure [1801] ends.

### CONCLUDING COMMENTS

The preceding paragraphs present detailed examples of embodiments in which multicast flow-zone switching multicast delivers frames efficiently in a network.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that any claims are intended to cover all of the generic and specific features of the invention herein described and all statements of the scope of the invention which, as a matter of language, might be said to fall therebetween.

This description is presented to enable any person skilled in the art to make and use the embodiments. All matter contained in the above description and shown in the accompanying drawings is to be interpreted as illustrative examples and not in a limiting sense. Various modifications to the disclosed embodiments will be readily apparent to those skilled in the art, and the general principles described herein are applicable to other embodiments and applications without departing from the spirit and scope of the present disclosure.

The quantity of entities shown in the drawings and tables are for exemplification purposes only and does not indicate any restriction regarding the actual number of such entities. The division of entities is for clarity and does demand separation of such entities.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1.-42. (canceled)

43. A data switch, comprising a memory and one or more ports, configured to:
receive an ingress frame at an ingress port;
identify, from content of the ingress frame, a source branch identifier;
determine an arborescence set indicator;
identify a plurality of potential forwarding arborescences, each consistent with the arborescence set indicator and source branch identifier, from among a set of arborescences, each associated, in the memory, with one or more arborescence forwarding ports;
from the plurality of potential forwarding arborescences, select one or more as frame forwarding arborescences; and
forward, in an egress frame, content of the ingress frame to zero or more egress ports selected from among all arborescence forwarding ports associated with any of the frame forwarding arborescences.

44. The data switch of claim 43 further configured to determine the arborescence set indicator based solely on the value of an arborescence set indicator field within the ingress frame.

45. The data switch of claim 43 further configured to modify the value of an arborescence set indicator field in the egress frame, with respect to the arborescence set indicator field in the ingress frame, in accordance with the determined arborescence set indicator.

46. The data switch of claim 43 further configured to identify the ingress port and, based on the ingress port identity, select a single frame forwarding arborescence from the plurality of potential forwarding arborescences.

47. The data switch of claim 46 further configured to:
determine, from content of the frame, a destination zone map indicating destination zones of the frame;
compute, from the destination zone map, a destination branch map indicating destination branches of the frame;
identify, in the memory, a port branch map indicating branches reachable via the selected frame forwarding arborescence through a particular port; and
suppress forwarding of the egress frame to the particular port if no branch indicated in the destination branch map is also indicated in the port branch map.

48. The data switch of claim 43 further configured to:
determine, from content of the ingress frame, a destination zone map indicating destination zones of the frame;
identify, in the memory, a port zone map indicating zones reachable through a particular branch port; and
forward the frame to the particular branch port if, and only if, at least one zone indicated in the port zone map is also indicated in the destination zone map.

49. The data switch of claim 43 further configured to:
determine, from content of the ingress frame, a flow designation of the frame;
identify, in the memory, a destination station list listing one or more stored flow designations and, associated with each, zero or more station ports; and
forward the frame to each station port in the destination station list associated with a stored flow designation matching the flow designation of the frame.

50. A method of forwarding a frame by a data switch, configured with a memory and one or more ports, comprising:
receiving an ingress frame at an ingress port;
identifying, from content of the ingress frame, a source branch identifier;
determining an arborescence set indicator;
identifying a plurality of potential forwarding arborescences, each consistent with the arborescence set indicator and source branch identifier, from among a set of arborescences, each associated, in the memory, with one or more arborescence forwarding ports;
from the plurality of potential forwarding arborescences, selecting one or more as frame forwarding arborescences; and
forwarding, in an egress frame, content of the ingress frame to zero or more egress ports selected from among all arborescence forwarding ports associated with any of the frame forwarding arborescences.

51. The method of claim 50 wherein the data switch is further configured to determine the arborescence set indicator based solely on the value of an arborescence set indicator field within the ingress frame.

52. The method of claim 50 wherein the data switch is further configured to modify the value of an arborescence set indicator field in the egress frame, with respect to the arborescence set indicator field in the ingress frame, in accordance with the determined arborescence set indicator.

53. The method of claim 50 wherein the data switch is further configured to identify the ingress port and, based on the ingress port identity, select a single frame forwarding arborescence from the plurality of potential forwarding arborescences.

54. The method of claim 53 wherein the data switch is further configured to:
determine, from content of the frame, a destination zone map indicating destination zones of the frame;
compute, from the destination zone map, a destination branch map indicating destination branches of the frame;
identify, in the memory, a port branch map indicating branches reachable via the selected single frame forwarding arborescence through a particular port; and
suppress forwarding of the egress frame to the particular port if no branch indicated in the destination branch map is also indicated in the port branch map.

55. The method of claim 50 wherein the data switch is further configured to:
determine, from content of the ingress frame, a destination zone map indicating destination zones of the frame;
identify, in the memory, a port zone map indicating zones reachable through a particular branch port; and
forward the frame to the particular branch port if, and only if, at least one zone indicated in the port zone map is also indicated in the destination zone map.

56. The method of claim 50 wherein the data switch is further configured to:
determine, from content of the ingress frame, a flow designation of the frame;
identify, in the memory, a destination station list listing one or more stored flow designations and, associated with each, zero or more station ports; and
forward the frame to each station port in the destination station list associated with a stored flow designation matching the flow designation of the frame.

57. A computer program product comprising a non-transitory computer-readable storage medium storing instructions that when executed by a data switch, configured with a memory and one or more ports, enable the data switch to perform a method of forwarding a frame, comprising:
receiving an ingress frame at an ingress port;
identifying, from content of the ingress frame, a source branch identifier;
determining an arborescence set indicator;
identifying a plurality of potential forwarding arborescences, each consistent with the arborescence set indicator and source branch identifier, from among a set of arborescences, each associated, in the memory, with one or more arborescence forwarding ports;
from the plurality of potential forwarding arborescences, selecting one or more as frame forwarding arborescences; and
forwarding, in an egress frame, content of the ingress frame to zero or more egress ports selected from among all arborescence forwarding ports associated with any of the frame forwarding arborescences.

58. The computer program product of claim 57 wherein the data switch is further configured to determine the arborescence set indicator based solely on the value of an arborescence set indicator field within the ingress frame.

59. The computer program product of claim 57 wherein the data switch is further configured to modify the value of an arborescence set indicator field in the egress frame, with respect to the arborescence set indicator field in the ingress frame, in accordance with the determined arborescence set indicator.

60. The computer program product of claim 57 wherein the data switch is further configured to identify the ingress port and, based on the ingress port identity, select a single frame forwarding arborescence from the plurality of potential forwarding arborescences.

61. The computer program product of claim 60 wherein the data switch is further configured to:
determine, from content of the frame, a destination zone map indicating destination zones of the frame;
compute, from the destination zone map, a destination branch map indicating destination branches of the frame;
identify, in the memory, a port branch map indicating branches reachable via the selected single frame forwarding arborescence through a particular port; and
suppress forwarding of the egress frame to the particular port if no branch indicated in the destination branch map is also indicated in the port branch map.

62. The computer program product of claim 57 wherein the data switch is further configured to:
determine, from content of the ingress frame, a destination zone map indicating destination zones of the frame;
identify, in the memory, a port zone map indicating zones reachable through a particular branch port; and
forward the frame to the particular branch port if, and only if, at least one zone indicated in the port zone map is also indicated in the destination zone map.
